(19) United States
(12) Patent Application Publication
(10) Pub. No.: US 2024/0364097 A1
(43) Pub. Date: Oct. 31, 2024

(54) ELECTRIC WORK MACHINE

(71) Applicant: MAKITA CORPORATION, Anjo-shi (JP)

(72) Inventors: Kazuaki USAMI, Anjo-shi (JP); Masayuki OKAMURA, Anjo-shi (JP); Dai SUZUKI, Anjo-shi (JP); Kouichi TAKEDA, Anjo-shi (JP)

(73) Assignee: MAKITA CORPORATION, Anjo-shi (JP)

(21) Appl. No.: 18/637,892

(22) Filed: Apr. 17, 2024

(30) Foreign Application Priority Data
Apr. 27, 2023 (JP) 2023-073425
Jan. 26, 2024 (JP) 2024-010148

(51) Int. Cl. H02H 7/085; A01G 3/08; B27B 17/02; B27B 17/08

(52) U.S. Cl. CPC H02H 7/085; B27B 17/08; A01G 3/086; B27B 17/02

(57) ABSTRACT

An electric work machine according to the present disclosure includes: a motor; and a first control circuit. The first control circuit increases a first counter on the basis of the acquired or estimated line current value being greater than a current threshold. The first control circuit decreases the first counter on the basis of the calculated rotational speed being greater than a speed threshold. The first control circuit stops the motor on the basis of the first counter exceeding a first threshold.

### CROSS-REFERENCE TO RELATED APPLICATIONS

This application claims the benefits of Japanese Patent Application No. 2023-073425 filed with the Japan Patent Office on Apr. 27, 2023 and Japanese Patent Application No. 2024-010148 filed with the Japan Patent Office on Jan. 26, 2024, the contents of which are incorporated herein by reference in its entirety.

### BACKGROUND

The present disclosure relates to a technique for protecting a motor of an electric work machine.

A device disclosed in US 2014/0232352 A measures the value of a current flowing from a battery when an electric tool is driven by the power of the battery. The device increases a counter when the measured current value is greater than a predetermined upper limit value, and decreases the counter when the measured current value is smaller than the predetermined upper limit value. The device switches OFF the electric tool to protect the battery when the counter exceeds a predetermined value.

### SUMMARY

In a case where an electric tool is driven by the power of a battery, it is necessary to protect not only the battery but also a motor of the electric tool so as to avoid burnout. However, the motor is cooled by rotating. Therefore, the counter based only on a current flowing from the battery may deviate from an actual temperature of the motor. That is, there is a possibility that the motor cannot be appropriately protected by using the counter.

In one aspect of the present disclosure, it is desirable that the motor can be appropriately protected.

An electric work machine according to one aspect of the present disclosure includes: a motor; and a first control circuit. The motor receives a power from a power supply to be driven. The first control circuit detects or estimates a line current value. The line current value corresponds to the magnitude of a current flowing through the motor. The first control circuit calculates a rotational speed of the motor. The first control circuit increases a first counter on the basis of the line current value acquired or estimated being greater than a current threshold. The first control circuit decreases the first counter on the basis of the rotational speed calculated being greater than a speed threshold. The first control circuit stops the motor on the basis of the first counter exceeding a first threshold.

In a case where no current flows through the motor, the motor may rotate by inertia to be cooled. This makes it difficult to accurately estimate a reduction amount of a motor temperature, that is, the motor temperature only from the line current value. In the electric work machine according to one aspect of the present disclosure, the first counter is increased on the basis of the line current value and decreased on the basis of the rotational speed of the motor. Therefore, in the electric work machine, the first counter responds to the actual temperature of the motor with high accuracy. As a result, in the electric work machine, the motor can be appropriately protected.

### BRIEF DESCRIPTION OF THE DRAWINGS

Example embodiments of the present disclosure will be described below with reference to the accompanying drawings, in which:

FIG. 1 is a drawing illustrating the appearance of an electric work machine according to a first embodiment;

FIG. 2 is a diagram illustrating an electrical configuration of the electric work machine according to the first embodiment;

FIG. 3 is a flowchart illustrating a main process executed by a microcomputer of the electric work machine according to the first embodiment;

FIG. 4 is a flowchart illustrating a switch operation detection process executed by the microcomputer of the electric work machine according to the first embodiment;

FIG. 5 is a flowchart illustrating an AD conversion process executed by the microcomputer of the electric work machine according to the first embodiment;

FIG. 6 is a flowchart illustrating a battery communication process executed by the microcomputer of the electric work machine according to the first embodiment;

FIG. 7 is a flowchart illustrating an error detection process executed by the microcomputer of the electric work machine according to the first embodiment;

FIG. 8 is a flowchart illustrating a motor control process executed by the microcomputer of the electric work machine according to the first embodiment;

FIG. 9 is a flowchart illustrating an overload protection detection process executed by the microcomputer of the electric work machine according to the first embodiment;

FIG. 10A is a flowchart illustrating a part of an overload counter addition process executed by the microcomputer of the electric work machine according to the first embodiment;

FIG. 10B is a flowchart illustrating the remaining part of the overload counter addition process executed by the microcomputer of the electric work machine according to the first embodiment;

FIG. 11A is a flowchart illustrating a part of an overload counter subtraction process executed by the microcomputer of the electric work machine according to the first embodiment;

FIG. 11B is a flowchart illustrating the remaining part of the overload counter subtraction process executed by the microcomputer of the electric work machine according to the first embodiment;

FIG. 12 is a diagram illustrating a table of an addition value of the overload counter included in the electric work machine according to the first embodiment;

FIG. 13 is a diagram illustrating a table of a first counter threshold of the electric work machine according to the first embodiment;

FIG. 14 is a diagram illustrating a table of a subtraction value of the overload counter included in the electric work machine according to the first embodiment during rotation of a motor;

FIG. 15 is a diagram illustrating a table of a subtraction value of the overload counter included in the electric work machine according to the first embodiment during stop of the motor;

FIG. 16 is a time chart illustrating a temporal change of an actual temperature of the motor and the overload counter of the electric work machine according to the first embodiment in a case where no upper limit is set for a subtraction time;

FIG. 17 is a first time chart illustrating a temporal change of an actual temperature of the motor and the overload counter of the electric work machine according to the first embodiment in a case where an upper limit is set for a subtraction time;

FIG. 18 is a second time chart illustrating a temporal change of an actual temperature of the motor and the overload counter of the electric work machine according to the first embodiment in a case where an upper limit is set for a subtraction time;

FIG. 19 is a first time chart illustrating temporal changes of various parameters of the electric work machine according to the first embodiment;

FIG. 20 is a second time chart illustrating temporal changes of various parameters of the electric work machine according to the first embodiment;

FIG. 21 is a third time chart illustrating temporal changes of various parameters of the electric work machine according to the first embodiment;

FIG. 22 is a diagram illustrating an electrical configuration of an electric work machine according to a second embodiment;

FIG. 23A is a flowchart illustrating a part of an overload counter subtraction process executed by a microcomputer of the electric work machine according to the second embodiment;

FIG. 23B is a flowchart illustrating the remaining part of the overload counter subtraction process executed by a microcomputer of the electric work machine according to the second embodiment;

FIG. 24 is a flowchart illustrating a speed threshold calculation process executed by the microcomputer of the electric work machine according to the second embodiment;

FIG. 25 is a flowchart illustrating a subtraction value correction process executed by the microcomputer of the electric work machine according to the second embodiment;

FIG. 26 is a time chart illustrating temporal changes of various parameters of the electric work machine according to the second embodiment;

FIG. 27 is a diagram illustrating an electrical configuration of an electric work machine according to another embodiment; and

FIG. 28 is a diagram illustrating an electrical configuration of an electric work machine according to still another embodiment.

### DETAILED DESCRIPTION OF EXEMPLARY EMBODIMENTS

### Summary of Embodiments

In an embodiment, an electric work machine may be provided that includes at least one of the following features 1 to 7.
Feature 1: A motor configured to receive a power from a power supply to be driven.
Feature 2: A first control circuit.
Feature 3: The first control circuit acquires or estimates a line current value, the line current value corresponding to a magnitude of a current flowing through the motor.
Feature 4: The first control circuit calculates a rotational speed of the motor.
Feature 5: The first control circuit increases a first counter based on the line current value acquired or estimated being greater than a current threshold.
Feature 6: The first control circuit decreases the first counter based on the rotational speed calculated being greater than a speed threshold.
Feature 7: The first control circuit stops the motor based on the first counter exceeding a first threshold.

In the electric work machine including at least the features 1 to 7, the first counter is increased on the basis of the line current value and decreased on the basis of the rotational speed of the motor. Therefore, in the electric work machine, the first counter responds to an actual temperature of the motor with high accuracy. As a result, in the electric work machine, the motor can be appropriately protected.

In an embodiment, the electric work machine may include the following feature 8 in addition to or instead of at least one of the features 1 to 7 described above.
Feature 8: The first control circuit changes a decrease rate of the first counter according to the rotational speed calculated by the first control circuit.

In the electric work machine including at least the features 1 to 8, the decrease rate of the first counter is changed according to the rotational speed, so that the first counter is enabled to respond to the actual temperature of the motor with higher accuracy.

In an embodiment, the electric work machine may include the following feature 9 in addition to or instead of at least one of the features 1 to 8 described above.
Feature 9: The first control circuit increases the decrease rate according to an increase in the rotational speed calculated by the first control circuit.

In the electric work machine including at least the features 1 to 9, the decrease rate of the first counter is increased according to the increase in the rotational speed, so that the first counter is enabled to respond to the actual temperature of the motor with higher accuracy.

In an embodiment, the electric work machine may include at least one of the following features 10 to 14 in addition to or instead of at least one of the features 1 to 7 described above.
Feature 10: The power supply includes a battery pack connected to the electric work machine, and the battery pack includes a first battery or a second battery.
Feature 11: A memory devise stores first correspondence data and second correspondence data, the first correspondence data and the second correspondence data each indicating correspondence relation between the rotational speed and a decrease rate of the first counter, and the first correspondence data being different from the second correspondence data.
Feature 12: The first control circuit selects the first correspondence data based on the battery pack including the first battery.
Feature 13: The first control circuit selects the second correspondence data based on the battery pack including the second battery.
Feature 14: The first control circuit decreases the first counter based on the first correspondence data selected or second correspondence data selected.

In the electric work machine including at least the features 1 to 7 and 10 to 14, the first counter is enabled to respond to the actual temperature of the motor with higher accuracy by changing the correspondence data to be selected depending on whether the battery pack includes the first battery or the second battery.

In an embodiment, the electric work machine may include at least one of the following features 15 and 16 in addition to or instead of at least one of the features 1 to 7 and 10 to 14 described above.
Feature 15: The first battery has a first internal resistance.
Feature 16: The second battery has a second internal resistance different from the first internal resistance.

In the electric work machine including at least the features 1 to 7 and 10 to 16, the first counter is enabled to respond to the actual temperature of the motor with higher accuracy by changing the correspondence data according to the internal resistance of the battery.

In an embodiment, the electric work machine may include at least one of the following features 17 to 19 in addition to or instead of at least one of the features 1 to 7 and 10 to 14.
Feature 17: The battery pack includes: a second counter; and a second control circuit configured to increase or decrease the second counter based on a charge/discharge current from the first battery or the second battery, and stop discharge from the first battery or the second battery based on the second counter exceeding a second threshold.
Feature 18: The second control circuit sets the second threshold to a first battery threshold based on the battery pack including the first battery.
Feature 19: The second control circuit sets the second threshold to a second battery threshold different from the first battery threshold based on the battery pack including the second battery.

In the electric work machine including at least the features 1 to 7, 10 to 14, and 17 to 19, the first counter is enabled to respond to the actual temperature of the motor with higher accuracy by changing the correspondence data according to the second threshold.

In an embodiment, the electric work machine may include at least one of the following features 20 and 21 in addition to or instead of at least one of the features 1 to 7 described above.
Feature 20: The first control circuit decreases a decrease rate of the first counter according to an increase in count of executing a protection operation of the motor.
Feature 21: Executing the protection operation corresponds to stopping the motor when the first counter exceeds the first threshold.

In the electric work machine including at least the features 1 to 7 and 20 to 21, the decrease rate of the first counter is decreased according to the increase in the execution count of the protection operation, so that the first counter is enabled to respond to the actual temperature of the motor with higher accuracy.

In an embodiment, the electric work machine may include the following feature 22 in addition to or instead of at least one of the features 1 to 7 described above.
Feature 22: The first control circuit stops decreasing the first counter based on a first time having reached a first time threshold during rotation of the motor, the first time corresponding to a time elapsed from starting to decrease the first counter during rotation of the motor.

In the electric work machine including at least the features 1 to 7 and 22, the first counter can be inhibited from deviating from the actual temperature of the motor by stopping decreasing the first counter on the basis of the first time having reached the first time threshold.

In an embodiment, the electric work machine may include the following feature 23 in addition to or instead of at least one of the features 1 to 7 described above.
Feature 23: The first control circuit (i) decreases the first counter, and (ii) stops decreasing the first counter based on a second time having reached a second time threshold during stop of the motor, the second time corresponding to a time elapsed from starting to decrease the first counter during stop of the motor.

In the electric work machine including at least the features 1 to 7 and 23, the first counter can be inhibited from deviating from the actual temperature of the motor by stopping decreasing the first counter when the second time reached the second time threshold.

In an embodiment, the electric work machine may include at least one of the following features 24 and 25 in addition to or instead of at least one of the features 1 to 7 described above.
Feature 24: A drive circuit configured to input an output of the power supply to the motor based on a voltage command value (for example, a duty ratio) output from the first control circuit, the voltage command value being directed by the first control circuit and corresponding to a magnitude of a voltage input to the motor.
Feature 25: The first control circuit calculates the speed threshold based on a power supply voltage value and/or the voltage command value, the power supply voltage value corresponding to a magnitude of a power supply voltage output from the power supply.

In the electric work machine including at least the features 1 to 7, 24, and 25, the speed threshold is calculated on the basis of the power supply voltage value and/or the voltage command value, that is, on the basis of a motor voltage value input to the motor. In a case where the motor is subjected to constant rotation control, the rotational speed is maintained even when a large load is applied to the motor. As a result, the line current value becomes greater than the current threshold and the rotational speed becomes greater than the speed threshold, so that the decrease and increase of the first counter may occur at the same time. Here, the motor voltage value increases as the load increases even when the rotational speed is constant. Therefore, the first control circuit calculates the speed threshold on the basis of the motor voltage value, so that the decrease of the first counter can be inhibited according to the load. As a result, it is possible to inhibit the simultaneous occurrence of the decrease and increase of the first counter.

In an embodiment, the electric work machine may include the following feature 26 in addition to or instead of at least one of the features 1 to 7, 24, and 25 described above.
Feature 26: The first control circuit calculates the speed threshold to be greater according to an increase in the power supply voltage value or the voltage command value.

In the electric work machine including at least the features 1 to 7 and 24 to 26, the speed threshold is calculated to be greater according to the increase in the motor voltage value. As a result, in a case where a heavy load is applied to the motor, the decrease of the first counter is inhibited. Therefore, in a case where a heavy load is applied to the motor during constant rotation control, it is possible to inhibit an inappropriate decrease of the first counter.

In an embodiment, the electric work machine may include at least one of the following features 27 and 28 in addition to or instead of at least one of the features 1 to 7, 24, and 25 described above.
Feature 27: The voltage command value includes a duty ratio.
Feature 28: The first control circuit calculates the speed threshold to be greater according to an increase in the product of the power supply voltage value and the duty ratio.

In the electric work machine including at least the features 1 to 7, 24, 25, 27, and 28, the speed threshold is calculated to be greater according to the increase in the motor voltage value. Therefore, in a case where a heavy load is applied to the motor during constant rotation control, it is possible to inhibit an inappropriate decrease of the first counter.

In an embodiment, the electric work machine may include at least one of the following features 29 and 30 in addition to or instead of at least one of the features 1 to 7 described above.
Feature 29: A voltage detection circuit configured to detect a motor voltage value, the motor voltage value corresponding to a magnitude of a voltage input to the motor.
Feature 30: The first control circuit calculates the speed threshold based on the motor voltage value detected by the voltage detection circuit.

In the electric work machine including at least the features 1 to 7, 29, and 30, the speed threshold is calculated on the basis of the motor voltage value, so that the decrease of the first counter can be inhibited according to a load applied to the motor. As a result, it is possible to inhibit the simultaneous occurrence of the decrease and increase of the first counter.

In an embodiment, the electric work machine may include the following feature 31 in addition to or instead of at least one of the features 1 to 7, 29, and 30 described above.
Feature 31: The first control circuit calculates the speed threshold to be greater according to an increase in the motor voltage value detected by the voltage detection circuit.

In the electric work machine including at least the features 1 to 7 and 29 to 31, the speed threshold is calculated to be greater according to the increase in the motor voltage value. As a result, in a case where a heavy load is applied to the motor during constant rotation control, it is possible to inhibit an inappropriate decrease of the first counter.

In an embodiment, the electric work machine may include the following feature 32 in addition to or instead of at least one of the features 1 to 7 described above.
Feature 32: The first control circuit calculates a decrease rate of the first counter based on the first counter.

In the electric work machine including at least the features 1 to 7 and 32, the decrease rate is calculated on the basis of the first counter. A motor temperature is reduced rapidly according to an increase in a temperature difference between an ambient temperature and the motor temperature. The temperature difference between the ambient temperature and the motor temperature increases according to an increase in the motor temperature. Therefore, a deviation between the first counter and the motor temperature can be reduced by calculating the decrease rate on the basis of the first counter.

In an embodiment, the electric work machine may include the following feature 33 in addition to or instead of at least one of the features 1 to 7 and 32 described above.
Feature 33: The first control circuit calculates the decrease rate to be greater according to an increase in the first counter.

In the electric work machine including at least the features 1 to 7, 32, and 33, the decrease rate is calculated to be greater according to the increase in the first counter. As a result, the deviation between the first counter and the motor temperature can be further reduced, and the motor can be appropriately protected.

In an embodiment, a method for controlling a motor may be provided that is a method including:
increasing a counter based on a line current value being greater than a current threshold, the line current value corresponding to the magnitude of a current flowing through the motor;
decreasing the counter based on a rotational speed of the motor being greater than a speed threshold; and
stopping the motor based on the counter exceeding a threshold.

According to the method for controlling a motor, effects similar to those of the electric work machine including the features 1 to 7 are obtained.

In an embodiment, the features 1 to 33 described above may be combined in any way.

In an embodiment, any of the features 1 to 33 described above may be excluded.

### First Exemplary Embodiment of Summary of Embodiments

### <1. Configuration>

### <1-1. Overall Configuration>

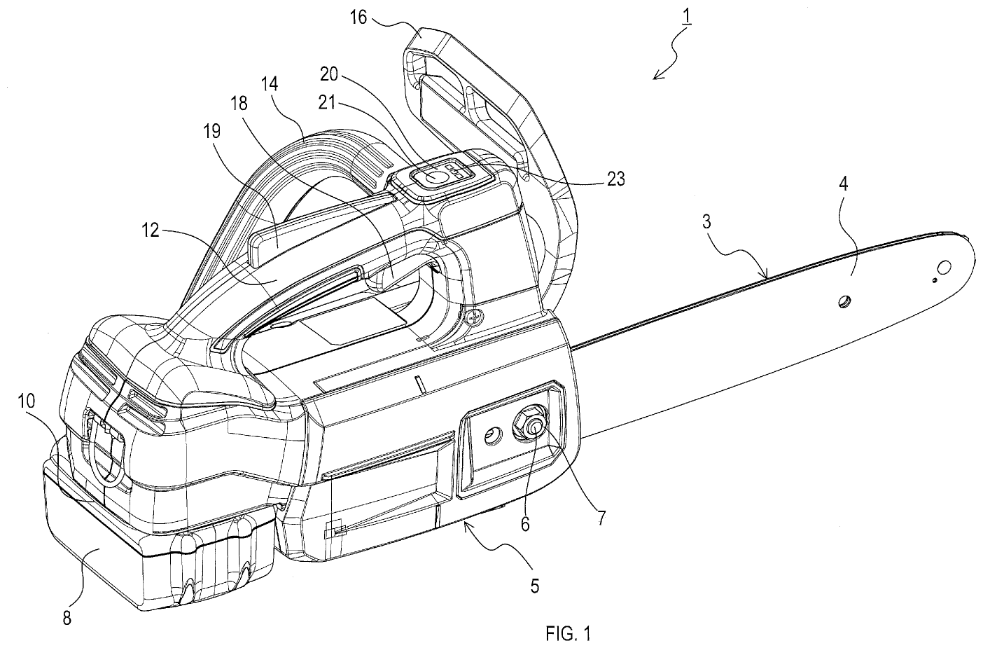

A configuration of an electric work machine 1 according to the present disclosure will be described with reference to FIG. 1. The electric work machine 1 according to the present embodiment is a chain saw that is a type of electric tool.

The electric work machine 1 includes a main body 5, a saw chain 3, and a guide bar 4. The saw chain 3 is attached to the guide bar 4. The guide bar 4 is fixed to the main body 5 by a bolt 6 and a nut 7 and protrudes from the main body 5. In the present embodiment, a direction in which the guide bar 4 protrudes is referred to as front, and its opposite direction is referred to as rear. A right side with respect to the front is referred to as right, and a left side with respect to the front is referred to as left.

The bolt 6 is inserted into a through hole (not illustrated) formed in the main body 5 and protrudes from the inside to the outside of the main body 5. When the bolt 6 is screwed with the nut 7 outside the main body 5, the guide bar 4 is fixed to the main body 5.

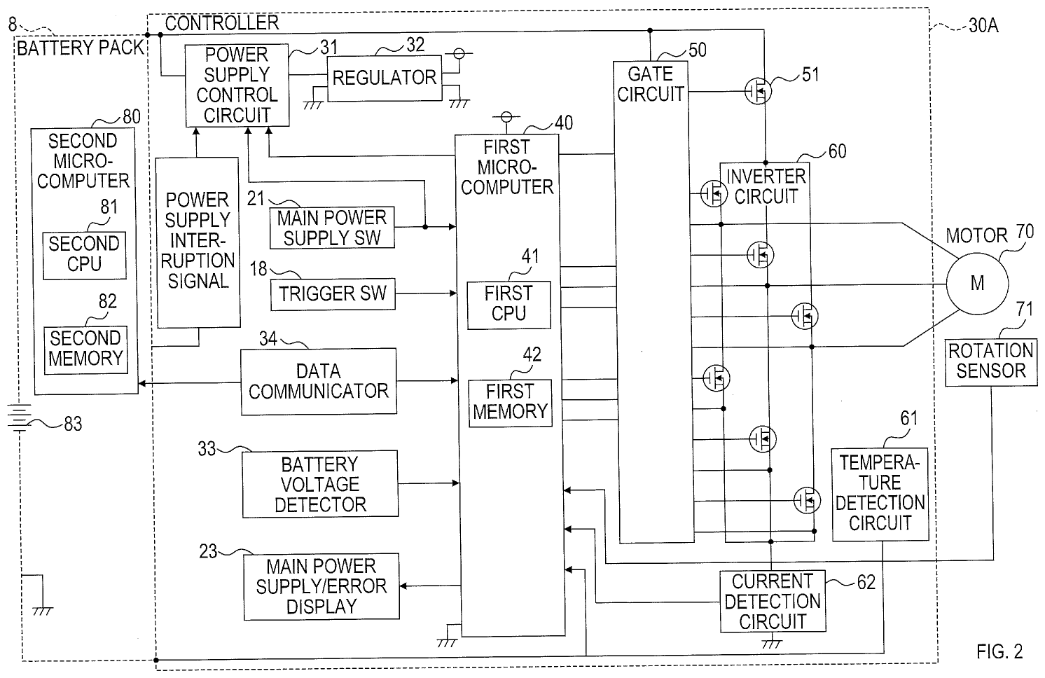

The guide bar 4 rotatably supports the saw chain 3 together with a sprocket (not illustrated) built in the main body 5. The main body 5 accommodates a motor 70 and a controller 30A illustrated in FIG. 2. The motor 70 drives the saw chain 3 by rotating the sprocket. The saw chain 3 moves along the outer periphery of the guide bar 4.

The electric work machine 1 includes a first grip 12 and a second grip 14. The first grip 12 connects a front end to a rear end of the main body 5 on an upper surface of the main body 5. A space is formed between the first grip 12 and the upper surface of the main body 5. The second grip 14 connects a left side surface of a front portion of the first grip 12 to a left side surface of a rear portion of the main body 5. A user grips the first grip 12 with the right hand and grips the second grip 14 with the left hand to use the electric work machine 1.

The electric work machine 1 includes a hand guard 16. The hand guard 16 is disposed in front of the first grip 12 and connected to an emergency stop mechanism of the motor 70. When the user pushes down the hand guard 16 forward while gripping the second grip 14, the motor 70 comes to an emergency stop.

The electric work machine 1 includes a battery attachment part 10. The battery attachment part 10 is disposed at a rear portion of a lower surface of the main body 5. A battery pack 8 is detachably attached on the battery attachment part 10. In the present embodiment, the battery pack 8 corresponds to an example of the power supply of the summary of embodiments.

The electric work machine 1 includes an operation panel 20. The operation panel 20 is disposed on a front portion of an upper surface of the first grip 12. The operation panel 20 includes a main power supply switch 21 and a main power supply/error display 23. The main power supply switch 21 includes a tact switch. The main power supply switch 21 is turned ON when pressed by the user, and outputs a main power supply signal indicating ON to a first microcomputer 40 described later. The main power supply switch 21 is turned OFF when released by the user, and outputs a main power supply signal indicating OFF to the first microcomputer 40. Every time the main power supply signal is switched from ON to OFF, a main power supply is switched between ON and OFF states.

The main power supply/error display 23 includes two or more Light emitting diodes (LEDs) of different colors. The main power supply/error display 23 goes off when the main power supply is in OFF state, and lights up or blinks when the main power supply is in ON state. When the main power supply is in ON state, the main power supply/error display 23 lights up or blinks in different colors depending on whether the electric work machine 1 is usable or unusable. In a state where the electric work machine 1 is unusable, an error occurs in the electric work machine 1. The main power supply/error display 23 lights up or blinks in different colors according to the type of the error. The type of the error includes a high temperature state of the motor 70, an overload state of the motor 70, a high temperature state of the battery pack 8, a low remaining energy of the battery pack 8, and the like.

The electric work machine 1 includes a trigger switch 18. The trigger switch 18 is disposed on a lower surface of the front portion of the first grip 12. The user pulls the trigger switch 18 to drive the motor 70 and releases the trigger switch 18 to stop the motor 70. When pulled by the user, the trigger switch 18 outputs a trigger signal indicating ON to the first microcomputer 40. When released by the user, the trigger switch 18 outputs a trigger signal indicating OFF to the first microcomputer 40.

The electric work machine 1 includes an unlocking lever 19. The unlocking lever 19 is disposed on the upper surface of the first grip 12 and behind the operation panel 20. When the user pushes down the unlocking lever 19, the unlocking lever 19 is disengaged from the trigger switch 18. As a result, the user can pull the trigger switch 18. When the user does not push down the unlocking lever 19, the user cannot pull the trigger switch 18. The user can pull the trigger switch 18 with the fingertip by gripping the first grip 12 while pushing the unlocking lever 19.

### <1-2. Electrical Configuration>

An electrical configuration of the electric work machine 1 will be described with reference to FIG. 2. The electric work machine 1 includes the motor 70. The motor 70 is a three-phase brushless motor. The electric work machine 1 includes a rotation sensor 71. The rotation sensor 71 includes three Hall sensors. The three Hall sensors are disposed corresponding to three-phase windings of the motor 70. Every time a rotor of the motor 70 rotates through an electrical angle of 60 degrees, the three Hall sensors sequentially output position signals to the first microcomputer 40. The position signal indicates a rotational position of the motor 70 (specifically, the rotor). In another embodiment, the motor 70 may be a brushed motor. Whether the motor 70 is a brushless motor or a brushed motor, the electric work machine 1 does not have to include the rotation sensor 71. In a case where the electric work machine 1 does not include the rotation sensor 71, the first microcomputer 40 may estimate a rotational speed of the motor 70 on the basis of an induced voltage of the winding of the motor 70. The first microcomputer 40 may use the estimated rotational speed instead of an actual rotational speed ωa.

The electric work machine 1 includes the controller 30A. The controller 30A includes a power supply control circuit 31, a regulator 32, the first microcomputer 40, a battery voltage detector 33, a data communicator 34, a gate circuit 50, an interruption switch 51, an inverter circuit 60, a temperature detection circuit 61, and a current detection circuit 62. In the controller 30A according to another embodiment, at least some of the power supply control circuit 31, the regulator 32, the first microcomputer 40, the battery voltage detector 33, the data communicator 34, the gate circuit 50, the interruption switch 51, the inverter circuit 60, the temperature detection circuit 61, and the current detection circuit 62 may be deleted.

The power supply control circuit 31 is connected to a positive electrode of the battery pack 8, and controls the regulator 32 on the basis of a power supply interruption signal and a main power supply switch signal. The power supply interruption signal is output from the battery pack 8 to the power supply control circuit 31 in a case where the remaining energy of the battery pack 8 is less than a predetermined amount. In a case where the power supply interruption signal is not output and the main power supply is in ON state, the power supply control circuit 31 causes the regulator 32 to generate power to be supplied to each circuit of the controller 30A. In a case where the power supply interruption signal is output or the main power supply is in OFF state, the power supply control circuit 31 stops the regulator 32.

The inverter circuit 60 is connected to a positive electrode of a battery 83 via the interruption switch 51. The inverter circuit 60 is a full-bridge circuit including three low-side switching elements and three high-side switching elements. Each switching element is, for example, a Metal-oxide-semiconductor field-effect transistor (MOSFET). The interruption switch 51 is a switching element such as a MOSFET. The inverter circuit 60 corresponds to an example of the drive circuit of the summary of embodiments.

The gate circuit 50 controls ON/OFF of each switching element of the inverter circuit 60 on the basis of a motor control signal input from the first microcomputer 40. The inverter circuit 60 applies a voltage according to ON or OFF of each switching element to the three-phase windings of the motor 70. The gate circuit 50 controls ON/OFF of the interruption switch 51 on the basis of a switch control signal input from the first microcomputer 40. When the interruption switch 51 is ON, the inverter circuit 60 is electrically connected with the battery 83 to receive a power from the battery 83. When the interruption switch 51 is OFF, the inverter circuit 60 is electrically interrupted from the battery 83.

The battery voltage detector 33 detects a battery voltage value Vbat, and outputs the detected battery voltage value Vbat to the first microcomputer 40. The battery voltage value Vbat corresponds to the magnitude of an output voltage of the battery pack 8.

The temperature detection circuit 61 detects a circuit temperature of the controller 30A, and outputs the detected circuit temperature to the first microcomputer 40.

The current detection circuit 62 detects a power supply current value and outputs the detected power supply current value to the first microcomputer 40. The power supply current value corresponds to the magnitude of a current flowing from the battery pack 8 to the motor 70.

The first microcomputer 40 includes a first CPU 41 and a first memory 42. The first memory 42 includes, for example, a semiconductor memory such as a ROM, a RAM, an NVRAM, and a flash memory. The first microcomputer 40 implements various functions by the first CPU 41 executing a program stored in the first memory 42. The first microcomputer 40 also causes the first memory 42 to store temporary data generated according to various functions. In the present embodiment, the first microcomputer 40 corresponds to an example of the first control circuit of the summary of embodiments.

Some or all of the various functions implemented by the first microcomputer 40 may be achieved by executing a program (that is, by software process), or may be achieved by one or more pieces of hardware. For example, instead of or in addition to the first microcomputer 40, the controller 30A may include a logic circuit including a plurality of electronic components, may include an integrated circuit for a particular use such as an application specific integrated circuit (ASIC) and/or an application specific standard product (ASSP), or may include a programmable logic device such as a field programmable gate array (FPGA) capable of constructing any logic circuit.

The first microcomputer 40 executes serial communication with the battery pack 8 via the data communicator 34 and receives battery information indicating the type of the battery 83. The type of the battery 83 varies depending on a parameter of the battery 83. The parameter of the battery 83 includes at least one of an internal resistance of the battery 83, an internal inductance of the battery 83, a transient response characteristic of a current output of the battery 83, and the like. In the present embodiment, the parameter of the battery 83 includes the internal resistance, and the type of the battery 83 varies depending on the internal resistance. The battery information includes, for example, at least one of identification data such as a model number of the battery pack 8, the internal resistance of the battery 83, a use history of the battery 83, a protection threshold described later, and the like. The identification data of the battery pack 8 corresponds to the internal resistance of the battery 83, and the internal resistance can be acquired from the identification data. The use history of the battery 83 corresponds to the protection threshold, and the protection threshold can be acquired from the use history. The first microcomputer 40 receives a discharge permission signal or a discharge prohibition signal from the battery pack 8 via the data communicator 34. The discharge permission signal is transmitted from the battery pack 8 in a case where the battery 83 is in a dischargeable state, to permit discharge from the battery 83 to the motor 70. The discharge prohibition signal is transmitted from the battery pack 8 in a case where the battery 83 is not in a dischargeable state, to prohibit discharge from the battery 83 to the motor 70.

The first microcomputer 40 calculates a rotational speed of the motor 70 on the basis of the position signal. The first microcomputer 40 further generates the motor control signal and the switch control signal on the basis of the main power supply signal, the trigger signal, the circuit temperature, the battery voltage value Vbat, the power supply current value, the rotational speed of the motor 70, the battery information, and the discharge permission signal or the discharge prohibition signal. The first microcomputer 40 outputs the generated motor control signal and switch control signal to the gate circuit 50. The motor control signal is a pulse width modulation (PWM) signal. The first microcomputer 40 also controls the LEDs of the main power supply/error display 23 on the basis of the main power supply signal and the detected error of the motor 70 and/or the battery 83.

The battery pack 8 includes the battery 83 and a second microcomputer 80. The battery 83 is a chargeable and dischargeable secondary battery, and is, for example, a lithium ion battery. The battery 83 includes a plurality of battery cells connected in series.

The second microcomputer 80 includes a second CPU 81 and a second memory 82. The second memory 82 includes, for example, a semiconductor memory such as a ROM, a RAM, an NVRAM, and a flash memory. The second microcomputer 80 implements various functions by the second CPU 81 executing a program stored in the second memory 82. In the present embodiment, the second microcomputer 80 corresponds to an example of the second control circuit of the summary of embodiments.

The second microcomputer 80 increases or decreases a battery counter on the basis of a discharge current value and a charge current value. The discharge current value corresponds to the magnitude of a discharge current flowing out of the battery 83. The charge current value corresponds to the magnitude of a charge current flowing into the battery 83. Specifically, the second microcomputer 80 increases the battery counter when the discharge current value is equal to or more than a predetermined value. The second microcomputer 80 decreases the battery counter when the discharge current value is equal to or less than the predetermined value or when the charge current is flowing to the battery 83. The battery counter corresponds to accumulation of a load received by the battery 83, and the value of the battery counter increases according to an increase in the accumulation of the load. The second microcomputer 80 prohibits discharge from the battery 83 when the battery counter exceeds the protection threshold. The second microcomputer 80 also transmits the battery information including the protection threshold to the first microcomputer 40.

### <2. Process>

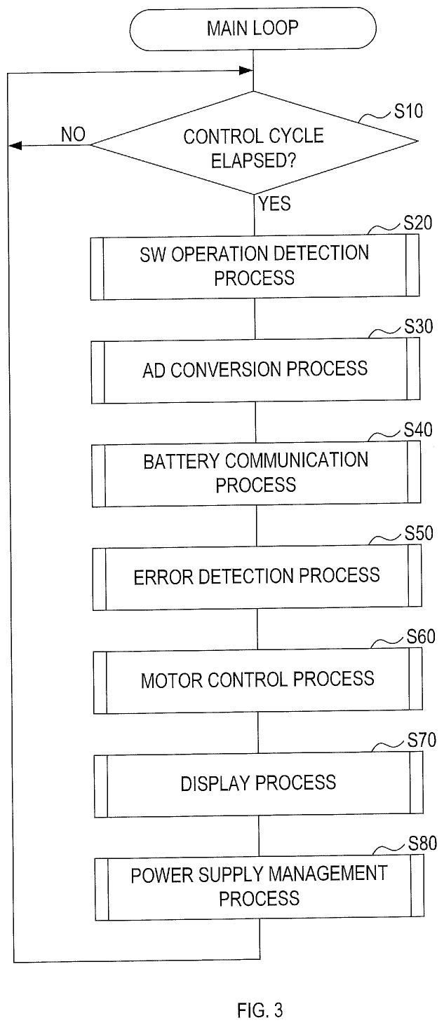

Main processing executed by the first microcomputer 40 will be described with reference to FIG. 3. The first microcomputer 40 repeatedly executes this process at a predetermined control cycle.

In S10, the first microcomputer 40 determines whether the control cycle has elapsed since the start of the present processing cycle. The control cycle is set in advance. When determining that the control cycle has elapsed (S10: YES), the first microcomputer 40 proceeds to S20. When determining that the control cycle has not elapsed (S10: NO), the first microcomputer 40 repeatedly executes S10.

In S20, the first microcomputer 40 executes a switch operation detection process to detect the operations of the main power supply switch 21 and the trigger switch 18 by a user. The details of the switch operation detection process will be described later. After executing the process in S20, the first microcomputer 40 proceeds to S30.

In S30, the first microcomputer 40 executes an AD conversion process to convert analog values of the circuit temperature, the battery voltage value Vbat, and the power supply current value into digital values. The first microcomputer 40 further estimates a line current value Itm. The line current value Itm corresponds to the magnitude of a current flowing through the winding of the motor 70. The details of the estimation of the line current value Itm will be described later. After executing S30, the first microcomputer 40 proceeds to S40.

In S40, the first microcomputer 40 executes a battery communication process to receive the battery information from the battery pack 8 via the data communicator 34. The details of the battery communication process will be described later. After executing S40, the first microcomputer 40 proceeds to S50.

In S50, the first microcomputer 40 executes an error detection process to detect the occurrence of an error in a case where it is necessary to protect the controller 30A, the motor 70, or the battery pack 8. When detecting the occurrence of an error, the first microcomputer 40 protects the controller 30A, the motor 70, or the battery pack 8. The type of the error includes an overcurrent error, an overload error, a high-temperature error, an overspeed error, a battery error, and the like. In the overcurrent error, an excessive current flows through the motor 70. In the overload error, the motor 70 receives an excessive load. In the high-temperature error, the circuit temperature is higher than a normal range. In the overspeed error, the rotational speed of the motor 70 exceeds an upper limit. In the battery error, the battery pack 8 is in a discharge prohibited state. The details of a detection process of the overload error will be described later. After executing S50, the first microcomputer 40 proceeds to S60.

In S60, the first microcomputer 40 executes a motor control process to control the driving of the motor 70. The details of the motor control process will be described later. After executing S60, the first microcomputer 40 proceeds S70.

In S70, the first microcomputer 40 executes a display process. Specifically, the first microcomputer 40 turns ON, blinks, or turns OFF the LED of a color corresponding to the type of the error in the main power supply/error display 23 on the basis of the state of the main power supply and the detected type of the error. After executing S70, the first microcomputer 40 proceeds to S80.

In S80, the first microcomputer 40 executes a power supply management process. Specifically, in a case where a change flag of the main power supply switch 21 is set to ON, the first microcomputer 40 switches the main power supply from ON state to OFF state or from OFF state to ON state. In a case where the trigger switch 18 is kept in OFF state while the main power supply is in ON state, the first microcomputer 40 switches the main power supply from ON to OFF to save power. After executing S80, the first microcomputer 40 returns to S10.

### <2-1. Switch Operation Detection Process>

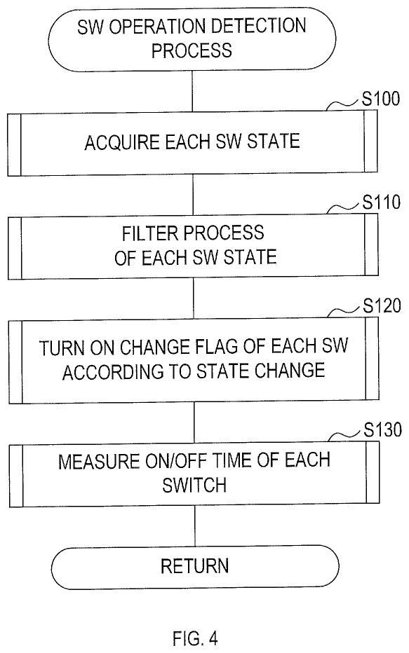

The switch operation detection process executed by the first microcomputer 40 in S20 will be described with reference to FIG. 4.

In S100, the first microcomputer 40 acquires the state of each switch. That is, the first microcomputer 40 acquires the main power supply signal from the main power supply switch 21 and acquires the trigger signal from the trigger switch 18. After executing S100, the first microcomputer 40 proceeds to S110.

In S110, the first microcomputer 40 applies a filter process to the signal acquired from each switch, and detects that the signal is ON in a case where the ON state continues for a certain period of time or longer. The first microcomputer 40 detects that the signal is OFF in a case where the OFF state continues for a certain period of time or longer. That is, the first microcomputer 40 does not detect an instantaneous change of the signal. After executing S110, the first microcomputer 40 proceeds to S120.

In S120, the first microcomputer 40 turns ON a change flag according to a state change of each switch. Specifically, the first microcomputer 40 turns ON a main power supply change flag in a case where the main power supply signal changes from ON to OFF or from OFF to ON. The first microcomputer 40 turns ON a trigger change flag in a case where the trigger signal changes from ON to OFF or from OFF to ON. After executing S120, the first microcomputer 40 proceeds to S130.

In S130, the first microcomputer 40 measures a time during which each switch is kept in ON state or a time during which each switch is kept in OFF state, and ends this process.

### <2-2. AD Conversion Process>

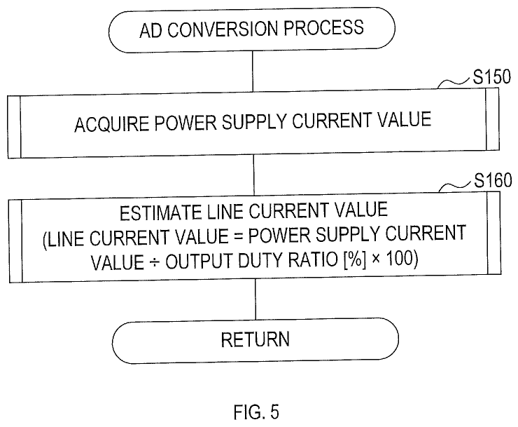

The line current estimation process in the AD conversion process executed by the first microcomputer 40 in S30 will be described with reference to FIG. 5.

In S150, the first microcomputer 40 converts the analog value of the power supply current value received from the current detection circuit 62 into a digital value to acquire the digital power supply current value.

In S160, the first microcomputer 40 estimates the line current value Itm on the basis of the power supply current value and an output duty ratio. The output duty ratio is a duty ratio of a PWM signal applied to the motor 70. Specifically, the first microcomputer 40 estimates the line current value Itm on the basis of the line current value Itm=power supply current value÷output duty ratio (%)×100. After executing S160, the first microcomputer 40 ends this process.

### <2-3. Battery Communication Process>

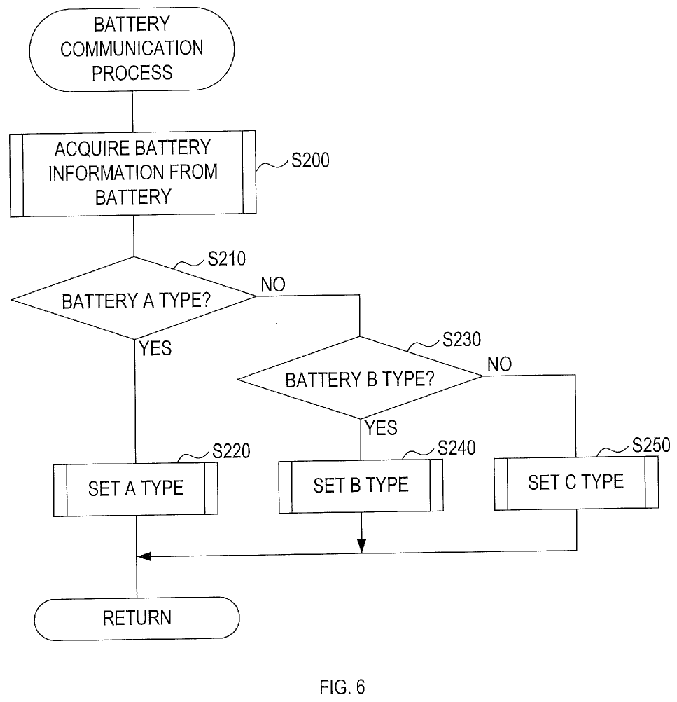

The battery communication process executed by the first microcomputer 40 in S40 will be described with reference to FIG. 6.

In S200, the first microcomputer 40 acquires the battery information from the battery pack 8 via the data communicator 34. The first microcomputer 40 acquires the internal resistance and/or the protection threshold of the battery 83 on the basis of the battery information. After executing S200, the first microcomputer 40 proceeds to S210.

In S210, the first microcomputer 40 determines whether the battery 83 is A type on the basis of the internal resistance and/or the protection threshold. In the present embodiment, three types: A type, B type, and C type are determined in advance as the type of the battery. The A type is a low resistance type having a relatively low internal resistance, or a high threshold type having a relatively high protection threshold. The C type is a high resistance type having a relatively high internal resistance, or a low threshold type having a relatively low protection threshold. The B type is intermediate between the A type and the C type, and is an intermediate resistance type having an intermediate internal resistance, or an intermediate threshold type having an intermediate protection threshold. When the battery deteriorates, the internal resistance increases. When the battery deteriorates, a small protection threshold is set in order to protect the battery 83. Therefore, the low resistance type corresponds to the high threshold type, and the high resistance type corresponds to the low threshold type. In another embodiment, two types may be determined or four or more types may be determined as the type of the battery.

When determining that the battery 83 is the A type (S210: YES), the first microcomputer 40 proceeds to pS220. When determining that the battery 83 is not the A type (S210: NO), the first microcomputer 40 proceeds to S230.

In S220, the first microcomputer 40 sets the battery type to “A type” and ends this process.

In S230, the first microcomputer 40 determines whether the battery 83 is the B type on the basis of the internal resistance and/or the protection threshold. When determining that the battery 83 is the B type (S230: YES), the first microcomputer 40 proceeds to process in S240. When determining that the battery 83 is not the B type (S230: NO), the first microcomputer 40 proceeds to S250.

In S240, the first microcomputer 40 sets the battery type to “B type” and ends this process.

In S250, the first microcomputer 40 sets the battery type to “C type” and ends this process.

### <2-4. Error Detection Process>

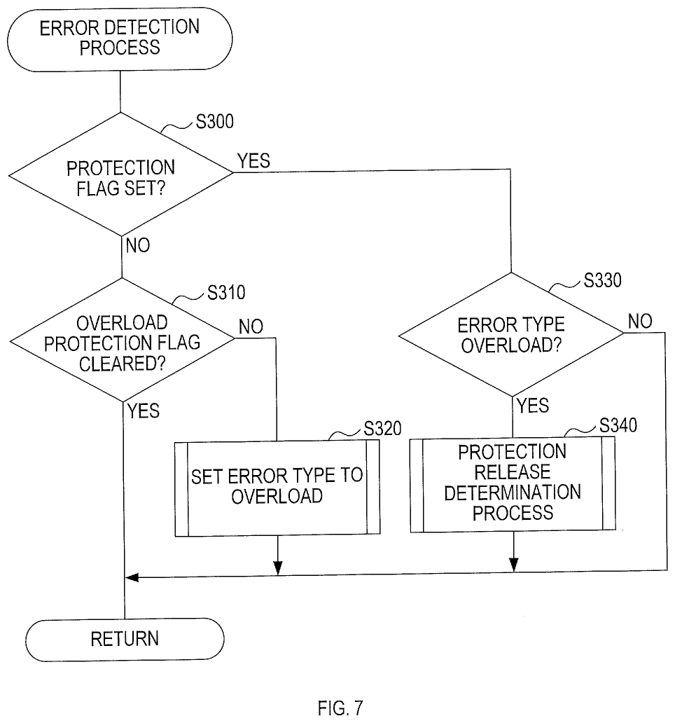

The overload error detection process in the error detection process executed by the first microcomputer 40 in S50 will be described with reference to FIG. 7. The overload error is a state in which the motor 70 receives an excessive load and the motor 70 has a high temperature. In a case where the motor 70 has a high temperature, it is necessary to stop the motor 70 to protect the motor 70 so that the motor 70 does not burn out.

In S300, the first microcomputer 40 determines whether a protection flag corresponding to the detected type of the error is set on the basis of the detection of any error. When determining that any protection flag is set (S300: YES), the first microcomputer 40 proceeds to S330. When determining that no protection flag is set (S300: NO), the first microcomputer 40 proceeds to S310.

In S310, the first microcomputer 40 determines whether an overload protection flag Flg is cleared. The overload protection flag Flg is set in a case where an overload error is detected in overload protection detection process described later. When determining that the overload protection flag Flg is cleared, the first microcomputer 40 ends this process. When determining that the overload protection flag Flg is set, the first microcomputer 40 proceeds to S320.

In S320, the first microcomputer 40 sets the error type to the overload, and ends this process.

In S330, the first microcomputer 40 determines whether the present error type is the overload. When determining that the error type is the overload (S330: YES), the first microcomputer 40 proceeds to S340. When determining that the error type is other than the overload (S330: NO), the first microcomputer 40 ends this process.

In S340, the first microcomputer 40 executes a protection release determination process. That is, the first microcomputer 40 determines whether the protection of the motor 70 according to the overload can be released. When determining that the protection of the motor 70 can be released, the first microcomputer 40 clears the overload protection flag Flg and ends this process.

### <2-5. Motor Control Process>

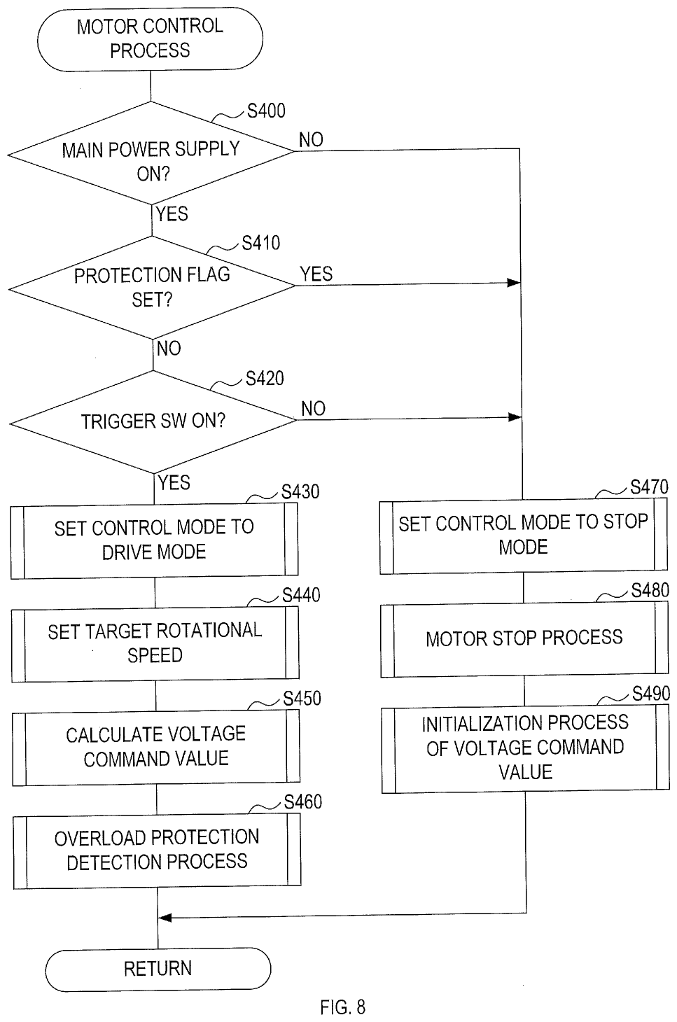

The motor control process executed by the first microcomputer 40 in S60 will be described with reference to FIG. 8.

In S400, the first microcomputer 40 determines whether the main power supply is in ON state. When determining that the main power supply is in ON state (S400: YES), the first microcomputer 40 proceeds to processing in S410. When determining that the main power supply is in OFF state (S400: NO), the first microcomputer 40 proceeds S470.

In S410, the first microcomputer 40 determines whether any protection flag is set. When determining that any protection flag is set (S410: YES), the first microcomputer 40 proceeds to S470. When determining that no protection flag is set (S410: NO), the first microcomputer 40 proceeds to S420.

In S420, the first microcomputer 40 determines whether the trigger switch 18 is in ON state. When determining that the trigger switch 18 is in ON state (S420: YES), the first microcomputer 40 proceeds to S430. When determining that the trigger switch 18 is in OFF state (S420: NO), the first microcomputer 40 proceeds to S470.

In S430, the first microcomputer 40 sets a control mode of the motor 70 to a drive mode, and proceeds to S440.

In S440, the first microcomputer 40 sets a target rotational speed oT of the motor 70, and proceeds to S450. In a case where the electric work machine 1 includes a plurality of operation modes, the target rotational speed ωT is determined for each operation mode. Thus, the first microcomputer 40 sets the target rotational speed ωT according to the set operation mode.

In S450, the first microcomputer 40 calculates a voltage command value indicating a voltage to be applied to the motor 70. For example, in a case where the first microcomputer 40 performs PWM control of the motor 70, the first microcomputer 40 calculates the output duty ratio of the PWM signal applied to the motor 70 as the voltage command value. Specifically, the first microcomputer 40 calculates the output duty ratio on the basis of a difference between the actual rotational speed ωa of the motor 70 and the target rotational speed ωT. The first microcomputer 40 outputs the PWM signal having the calculated output duty ratio to the gate circuit 50, and proceeds to S460. The first microcomputer 40 may perform vector control of the motor 70.

In S460, the first microcomputer 40 executes the overload protection detection process, and sets the overload protection flag when detecting the overload of the motor 70. The details of the overload protection detection process will be described later. After executing S460, the first microcomputer 40 ends this process.

In S470, the first microcomputer 40 sets the control mode of the motor 70 to a stop mode, and proceeds to S480.

In S480, the first microcomputer 40 executes stop process of the motor 70. Specifically, the first microcomputer 40 outputs the switch control signal for turning OFF the interruption switch 51 to the gate circuit 50. After executing S480, the first microcomputer 40 proceeds to S490.

In S490, the first microcomputer 40 executes an initialization process of the voltage command value to set the voltage command value to 0, and ends this process.

### <2-5-1. Overload Protection Detection Process>

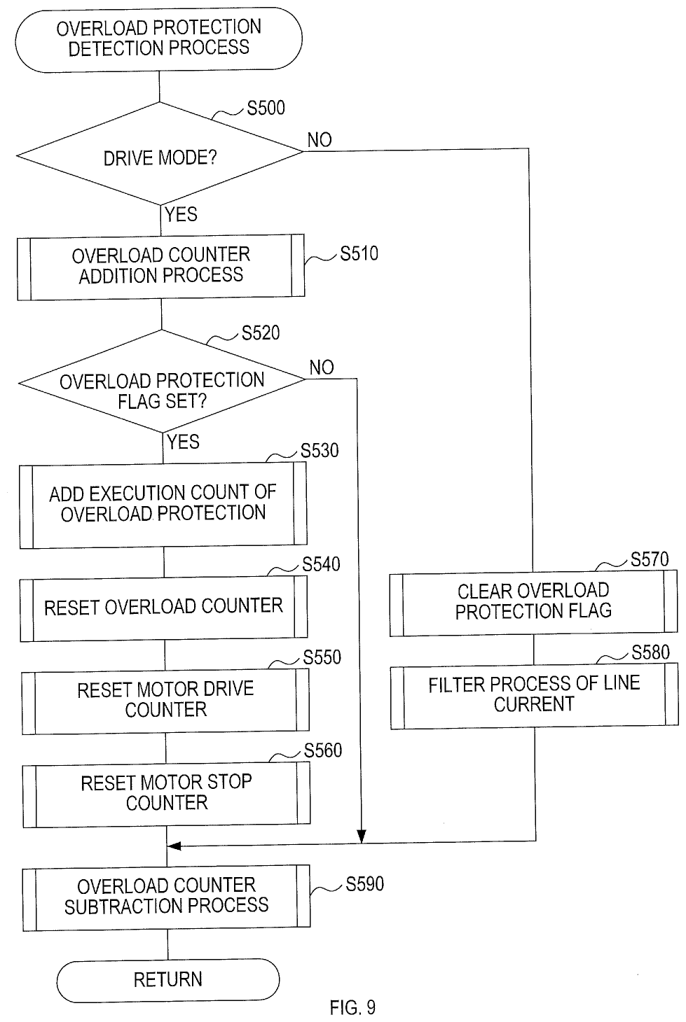

The overload protection detection process executed by the first microcomputer 40 in S460 will be described with reference to FIG. 9.

In S500, the first microcomputer 40 determines whether the control mode of the motor 70 is set to the drive mode. When determining that the control mode is set to the drive mode (S500: YES), the first microcomputer 40 proceeds to S510. When determining that the control mode is set to the stop mode (S500: NO), the first microcomputer 40 proceeds to S570.

In S510, the first microcomputer 40 executes an overload counter addition process, and proceeds to S520. Specifically, the first microcomputer 40 adds an addition value to an overload counter Co. The addition value is a value according to the line current value Itm and the type of the battery 83. The first microcomputer 40 sets the overload protection flag in a case where the overload counter Co is equal to or more than a first counter threshold Ta.

The overload counter Co corresponds to an estimated value of the temperature of the motor 70. It is difficult to measure the temperature of the motor 70. Therefore, the first microcomputer 40 increases or decreases the overload counter Co on the basis of factors of raising and lowering the temperature of the motor 70, and causes the overload counter Co to respond to the temperature of the motor 70. The details of the overload counter addition process will be described later. In the present embodiment, the temperature of the motor 70 corresponds to a temperature of a stator of the motor 70.

In S520, the first microcomputer 40 determines whether the overload protection flag Flg is set. When determining that the overload protection flag Flg is set (S520: YES), the first microcomputer 40 proceeds to S530. When determining that the overload protection flag Flg is cleared (S520: NO), the first microcomputer 40 proceeds to S590.

In S530, the first microcomputer 40 adds the execution count Nm of overload protection, and proceeds to S540. The overload protection is executed in response to the overload protection flag Flg being set. The execution count Nm is the number of times the overload protection is executed from when the battery pack 8 is connected to the electric work machine 1 to when the battery pack 8 is removed, and corresponds to the number of times the overload protection flag Flg is set.

In S540, the first microcomputer 40 resets the overload counter Co to 0, and proceeds to S550.

In S550, the first microcomputer 40 resets a motor drive counter Cd described later to 0, and proceeds to processing in S560.

In S560, the first microcomputer 40 resets a motor stop counter Cs described later to 0, and proceeds to S590.

In S570, the first microcomputer 40 clears the overload protection flag Flg and proceeds to S580.

In S580, the first microcomputer 40 applies a low-pass filter to the line current value Itm, and proceeds to S590.

In S590, the first microcomputer 40 executes an overload counter subtraction process. Specifically, the first microcomputer 40 subtracts a subtraction value from the overload counter Co. The subtraction value is a value according to the actual rotational speed ωa and the type of the battery 83. The details of the overload counter subtraction process will be described later. After executing S590, the first microcomputer 40 ends this process.

<2-5-1a. Overload Counter Addition Process>

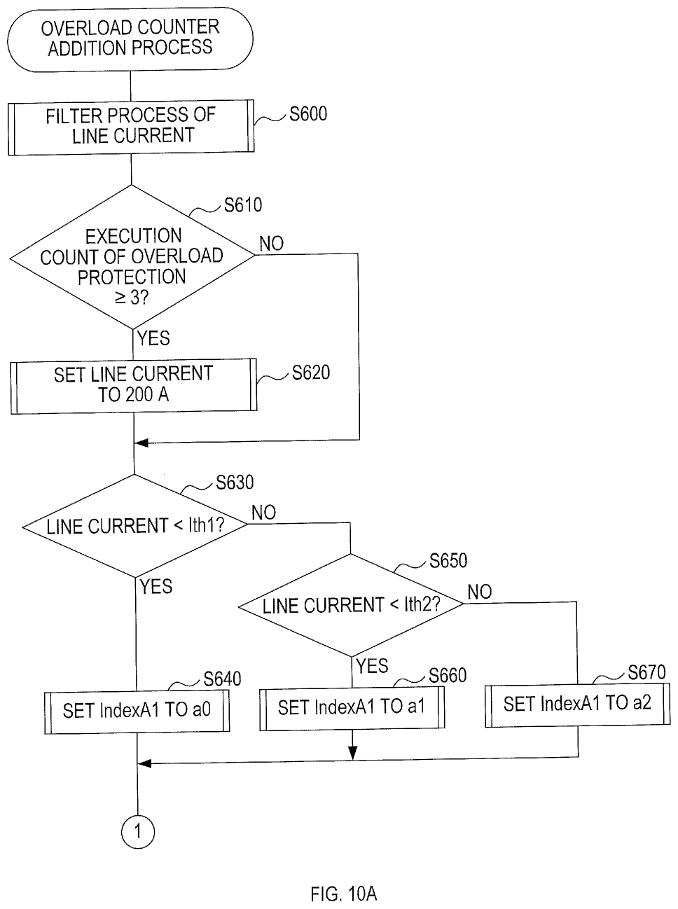

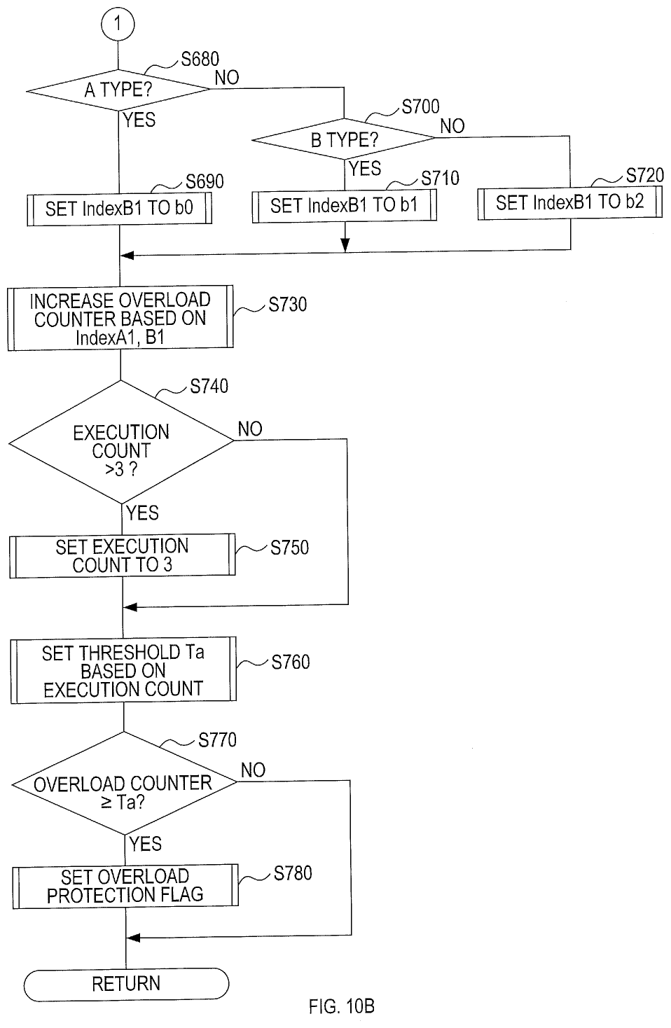

The overload counter addition process executed by the first microcomputer 40 in S510 will be described with reference to FIGS. 10A and 10B.

In S600, the first microcomputer 40 applies a low-pass filter to the line current value Itm to remove a sudden change in the line current value Itm, and proceeds to S610.

In S610, the first microcomputer 40 determines whether the execution count Nm is three times or more. Heat accumulated in the motor 70 increases according to an increase in the execution count Nm. Therefore, in a case where the overload protection is repeatedly executed, it is desirable to stop the motor 70. In the present embodiment, a determination threshold is set to 3 times in order to stop the motor 70 in a case where the overload protection is executed 3 times. In another embodiment, the determination threshold may be 2 times or 4 or more times. When determining that the execution count Nm is 3 times or more (S610: YES), the first microcomputer 40 proceeds to S620. When determining that the execution count Nm is 2 times or less (S610: NO), the first microcomputer 40 proceeds to S630.

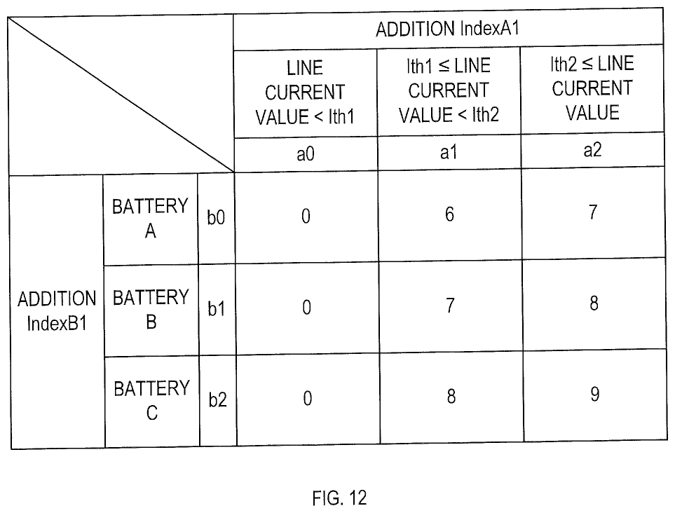

In S620, the first microcomputer 40 sets the line current value Itm to 200A, and proceeds to S630. The first memory 42 stores an addition value table. As illustrated in FIG. 12, the addition value table shows an addition value corresponding to the line current value Itm and the type of the battery 83. The addition value is a positive value. In the addition value table, the greater the line current value Itm, the greater the addition value, and the greater the internal resistance (or the smaller the protection threshold), the greater the addition value. The value 200A is a value that maximizes the addition value in each battery type. In another embodiment, the line current value Itm may be set to a value other than 200A as long as the value maximizes the addition value in each battery type. In yet another embodiment, the first memory 42 may store an addition rate table instead of the addition value table. The addition rate table shows an addition rate of the overload counter Co corresponding to the line current value Itm and the type of the battery 83. The first microcomputer 40 may increase the overload counter Co on the basis of the addition rate instead of the addition value.

In S630, the first microcomputer 40 determines whether the line current value Itm is smaller than a first current threshold Ith1. When determining that the line current value Itm is smaller than the first current threshold Ith1 (S630: YES), the first microcomputer 40 proceeds to S640. When determining that the line current value Itm is equal to or more than the first current threshold Ith1 (S630: NO), the first microcomputer 40 proceeds to S650.

In S640, the first microcomputer 40 sets an addition index A1 to a0, and proceeds to S680.

In S650, the first microcomputer 40 determines whether the line current value Itm is smaller than a second current threshold Ith2. The second current threshold Ith2 is greater than the first current threshold Ith1. When determining that the line current value Itm is smaller than the second current threshold Ith2 (S650: YES), the first microcomputer 40 proceeds to S660. When determining that the line current value Itm is equal to or more than the second current threshold Ith2 (S650: NO), the first microcomputer 40 proceeds to S670.

In S660, the first microcomputer 40 sets the addition index A1 to a1, and proceeds to S680.

In S670, the first microcomputer 40 sets the addition index A1 to a2, and proceeds to S680.

In S680, the first microcomputer 40 determines whether the type of the battery 83 is the A type. When determining that the type of the battery 83 is the A type (S680: YES), the first microcomputer 40 proceeds to S690. When determining that the type of the battery 83 is other than the A type (S680: NO), the first microcomputer 40 proceeds to S700.

In S690, the first microcomputer 40 sets an addition index B1 to b0, and proceeds to S730.

In S700, the first microcomputer 40 determines whether the type of the battery 83 is the B type. When determining that the type of the battery 83 is the B type (S700: YES), the first microcomputer 40 proceeds to S710. When determining that the type of the battery 83 is the C type (S700: NO), the first microcomputer 40 proceeds to S720.

In S710, the first microcomputer 40 sets the addition index B1 to b1, and proceeds to S730.

In S720, the first microcomputer 40 sets the addition index B1 to b2, and proceeds to S730.

In S730, the first microcomputer 40 acquires an addition value according to the set addition index A1 and addition index B1 from the addition value table. In each type of the battery 83, in a case where the line current value Itm is less than the first current threshold Ith1, the addition value is 0, and in a case where the line current value Itm is equal to or more than the first current threshold Ith1, the addition value is a value greater than 0. The first microcomputer 40 adds the acquired addition value to the overload counter Co, and proceeds to S740. In the present embodiment, the first current threshold Ith1 corresponds to an example of the current threshold of the summary of embodiments.

In S740, the first microcomputer 40 determines whether the execution count Nm is more than 3. When determining that the execution count Nm is more than 3 (S740: YES), the first microcomputer 40 proceeds to S750. When determining that the execution count Nm is 3 or less (S740: NO), the first microcomputer 40 proceeds to S760.

In S750, the first microcomputer 40 sets the execution count Nm to 3, and proceeds to S760.

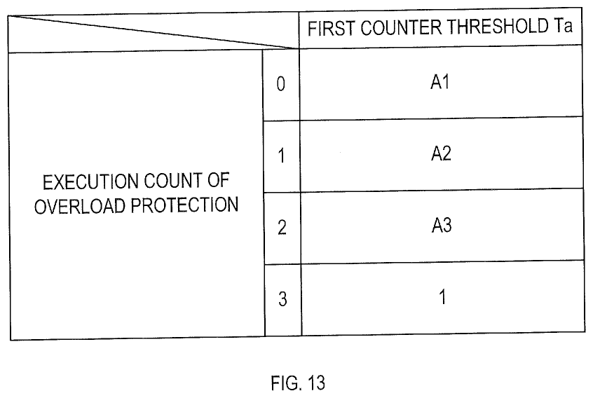

In S760, the first microcomputer 40 acquires the first counter threshold Ta according to the execution count Nm from a first counter threshold table, and proceeds to S770. Since the heat accumulated in the motor 70 increases according to an increase in the execution count Nm, the first microcomputer 40 changes the first counter threshold Ta according to the execution count Nm. The first memory 42 stores the first counter threshold table. As illustrated in FIG. 13, the first counter threshold table is a table of the first counter threshold Ta corresponding to the execution count Nm. The first microcomputer 40 acquires the first counter threshold Ta corresponding to the execution count Nm from the first counter threshold table. The first counter threshold Ta corresponding to Nm=3 is 1, and the first counter threshold Ta corresponding to Nm=2 is A3 greater than 1. The first counter threshold Ta corresponding to Nm=1 is A2 greater than A3. The first counter threshold Ta corresponding to Nm=0 is A1 greater than A2.

In S770, the first microcomputer 40 determines whether the overload counter Co is equal to or more than the first counter threshold Ta. When determining that the overload counter Co is equal to or more than the first counter threshold Ta (S770: YES), the first microcomputer 40 proceeds to S780. When determining that the overload counter Co is less than the first counter threshold Ta (S770: NO), the first microcomputer 40 ends this process.

In S780, the first microcomputer 40 sets the overload protection flag Flg and ends this process.

<2-5-1b. Overload Counter Subtraction Process>

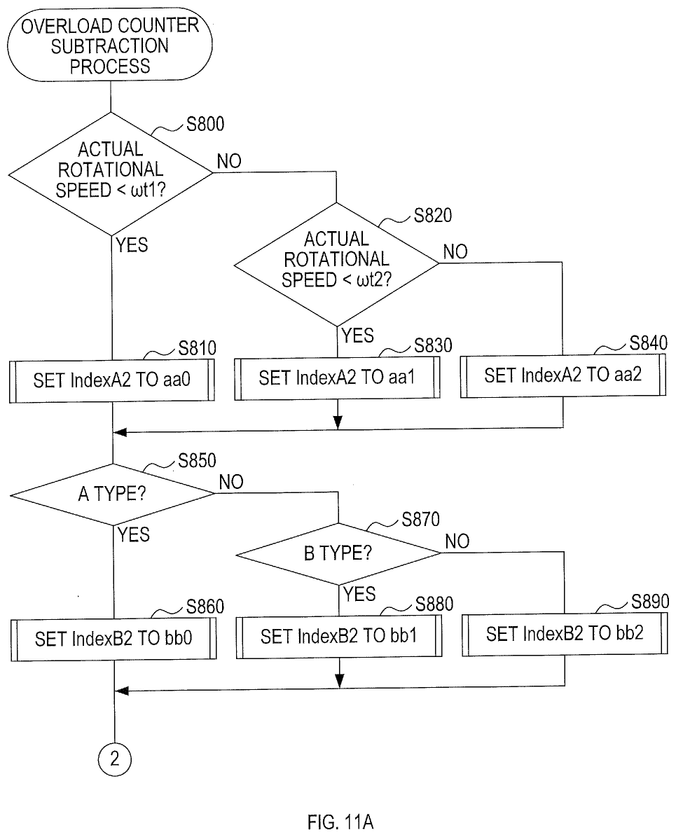

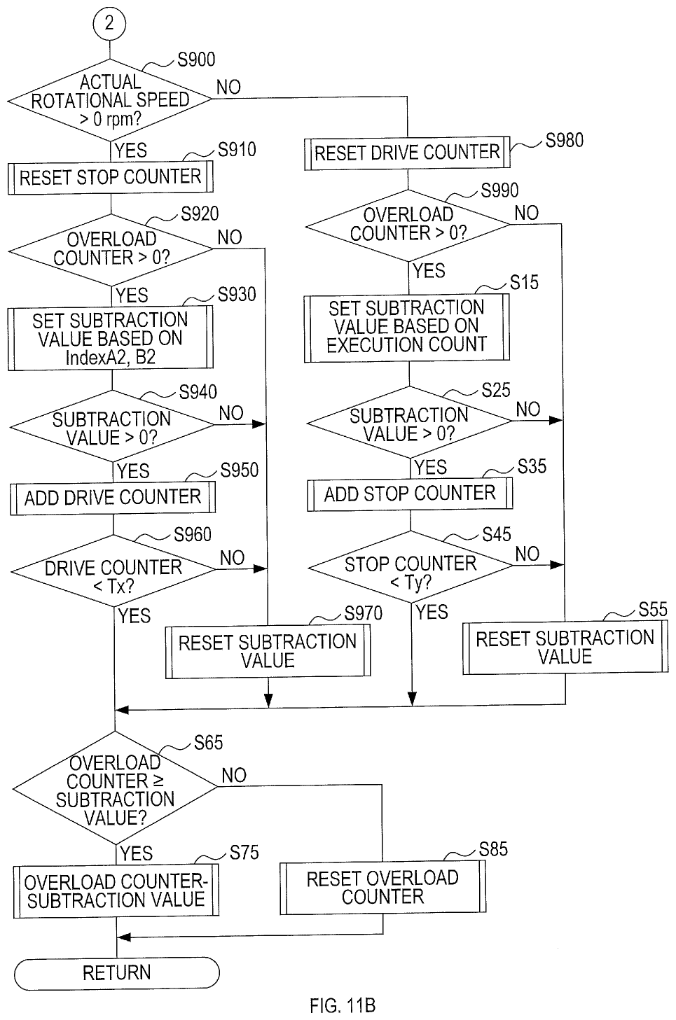

The overload counter subtraction process executed by the first microcomputer 40 in the processing in S590 will be described with reference to FIGS. 11A and 11B.

In S800, the first microcomputer 40 determines whether the actual rotational speed ωa of the motor 70 is smaller than a first speed threshold ωt1. When the motor 70 rotates, the motor 70 is cooled by the rotation of a fan included in the rotor. Suppose that no current flows through the motor 70 and the motor 70 rotates by inertia. In this case, the motor 70 is also cooled in a case where the actual rotational speed ωa is equal to or more than a predetermined speed.

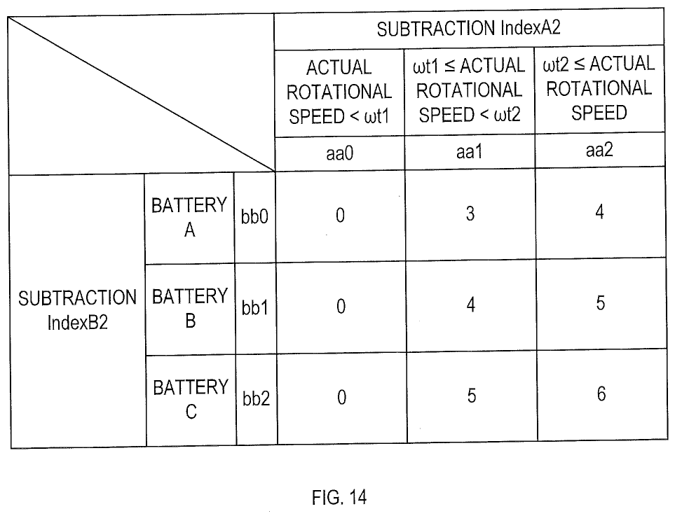

The first memory 42 stores a first subtraction value table. As illustrated in FIG. 14, the first subtraction value table shows a subtraction value corresponding to the actual rotational speed ωa and the type of the battery 83. The subtraction value is a positive value. In the first subtraction value table, the greater the actual rotational speed ωa, the greater the subtraction value, and the greater the internal resistance (or the smaller the protection threshold), the greater the subtraction value. In another embodiment, the first memory 42 may store a first subtraction rate table instead of the first subtraction value table. The first subtraction rate table shows a subtraction rate of the overload counter Co corresponding to the actual rotational speed ωa and the type of the battery 83. The first microcomputer 40 may decrease the overload counter Co on the basis of a subtraction rate.

When determining that the actual rotational speed ωa is smaller than the first speed threshold ωt1 (S800: YES), the first microcomputer 40 proceeds to S810. When determining that the actual rotational speed ωa is equal to or more than the first speed threshold t1 (S800: NO), the first microcomputer 40 proceeds to S820.

In S810, the first microcomputer 40 sets a subtraction index A2 to aa0, and proceeds to S850.

In S820, the first microcomputer 40 determines whether the actual rotational speed ωa is smaller than a second speed threshold ωt2. The second speed threshold ωt2 is greater than the first speed threshold ωt1. When determining that the actual rotational speed ωa is smaller than the second speed threshold ωt2 (S820: YES), the first microcomputer 40 proceeds to S830. When determining that the actual rotational speed ωa is equal to or more than the second speed threshold ωt2 (S820: NO), the first microcomputer 40 proceeds to S840.

In S830, the first microcomputer 40 sets the subtraction index A2 to aa1, and proceeds to S850.

In S840, the first microcomputer 40 sets the subtraction index A2 to aa2, and proceeds to S850.

In S850, the first microcomputer 40 determines whether the type of the battery 83 is the A type. When determining that the type of the battery 83 is the A type (S850: YES), the first microcomputer 40 proceeds to S860. When determining that the type of the battery 83 is other than the A type (S850: NO), the first microcomputer 40 proceeds to S870.

In S860, the first microcomputer 40 sets a subtraction index B2 to bb0, and proceeds to S900.

In S870, the first microcomputer 40 determines whether the type of the battery 83 is the B type. When determining that the type of the battery 83 is the B type (S870: YES), the first microcomputer 40 proceeds to S880. When determining that the type of the battery 83 is the C type (S870: NO), the first microcomputer 40 proceeds to S890.

In S880, the first microcomputer 40 sets the subtraction index B2 to bb1, and proceeds to S900.

In S890, the first microcomputer 40 sets the subtraction index B2 to bb2, and proceeds to S900.

In S900, the first microcomputer 40 determines whether the actual rotational speed ωa is greater than 0 rpm. That is, the first microcomputer 40 determines whether the motor 70 is rotating. When the rotor of the motor 70 stops, the motor 70 dissipates heat to be cooled. However, the reduction speed of the temperature of the motor 70 during stop of the motor 70 is lower than the reduction speed of the temperature of the motor 70 during driving of the motor 70. Therefore, a second subtraction rate is desirably smaller than the first subtraction rate. The first subtraction rate corresponds to a subtraction rate of the overload counter Co during the driving of the motor 70. The second subtraction rate corresponds to a subtraction rate of the overload counter Co during the stop of the motor 70. In S900, the first microcomputer 40 determines whether the motor 70 is rotating in order to change the subtraction rate from the first or the second subtraction rate to the second or the first subtraction rate.

When determining that the actual rotational speed ωa is greater than 0 rpm, that is, the motor 70 is rotating (S900: YES), the first microcomputer 40 proceeds to S910. When determining that the actual rotational speed ωa is 0 rpm or less, that is, the motor 70 stops (S900: NO), the first microcomputer 40 proceeds S980.

In S910, since the motor 70 is rotating, the first microcomputer 40 resets the motor stop counter Cs to 0, and proceeds to S920.

In S920, the first microcomputer 40 determines whether the overload counter Co is greater than 0. When determining that the overload counter Co is greater than 0 (S920: YES), the first microcomputer 40 proceeds to S930. When determining that the overload counter Co is 0 or less (S920: NO), the first microcomputer 40 proceeds to S970.

In S930, the first microcomputer 40 acquires a subtraction value according to the set subtraction index A2 and subtraction index B2 from the first subtraction value table, and proceeds to S940. In each battery type, in a case where the actual rotational speed ωa is less than the first speed threshold ωt1, the subtraction value is 0, and in a case where the actual rotational speed ωa is equal to or more than the first speed threshold ωt1, the subtraction value is a value greater than 0. In the present embodiment, the first speed threshold ωt1 corresponds to an example of the speed threshold of the summary of embodiments.

In a load range of the motor 70 assumed in the present embodiment, the first current threshold Ith1 and the first speed threshold ωt1 are determined so that (i) in a case where the line current value Itm is equal to or more than the first current threshold Ith1, the actual rotational speed ωa becomes less than the first speed threshold ωt1, and (ii) in a case where the actual rotational speed ωa is equal to or more than the first speed threshold ωt1, the line current value becomes less than the first current threshold Ith1. That is, the first current threshold Ith1 and the first speed threshold ωt1 are determined so that (i) in a case where the addition value is greater than 0, the subtraction value is 0, and (ii) in a case where the subtraction value is greater than 0, the addition value is 0. As a result, the increase of the overload counter Co does not occur simultaneously with the decrease of the overload counter Co.

In S940, the first microcomputer 40 determines whether the subtraction value acquired in S930 is greater than 0. When determining that the subtraction value is greater than 0 (S940: YES), the first microcomputer 40 proceeds to S950. When determining that the subtraction value is 0 or less (S940: NO), the first microcomputer 40 proceeds to S970.

In S950, the first microcomputer 40 adds a fixed value to the motor drive counter Cd, and proceeds to S960. The motor drive counter Cd corresponds to a time elapsed from a time point of starting to decrease the overload counter Co during rotation of the motor 70.

In S960, the first microcomputer 40 determines whether the motor drive counter Cd is smaller than a second counter threshold Tx. When determining that the motor drive counter Cd is smaller than the second counter threshold Tx (S960: YES), the first microcomputer 40 proceeds to S65. When determining that the motor drive counter Cd is equal to or more than the second counter threshold Tx (S960: NO), the first microcomputer 40 proceeds to S970.

In S970, the first microcomputer 40 resets the subtraction value to 0, and proceeds to S65. As a result, when the time elapsed from the time point of starting to decrease the overload counter Co reaches the second counter threshold Tx during the rotation of the motor 70, the decrease of the overload counter Co is stopped.

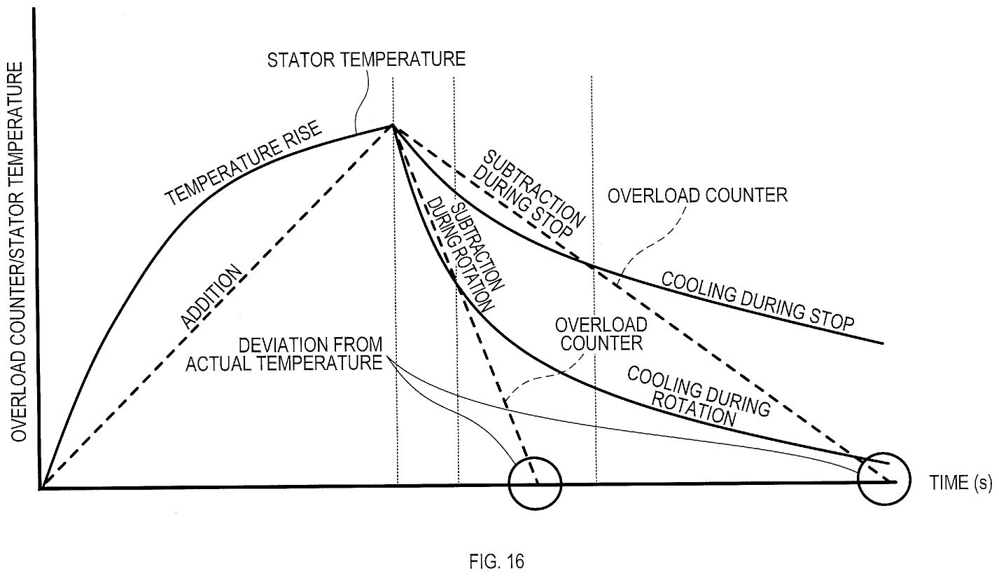

As illustrated in FIG. 16, when the motor 70 rotates, the stator temperature of the motor 70 is rapidly reduced and then gradually reduced. Therefore, when the overload counter Co continues to decrease during the rotation of the motor 70, the overload counter Co deviates from the stator temperature of the motor 70.

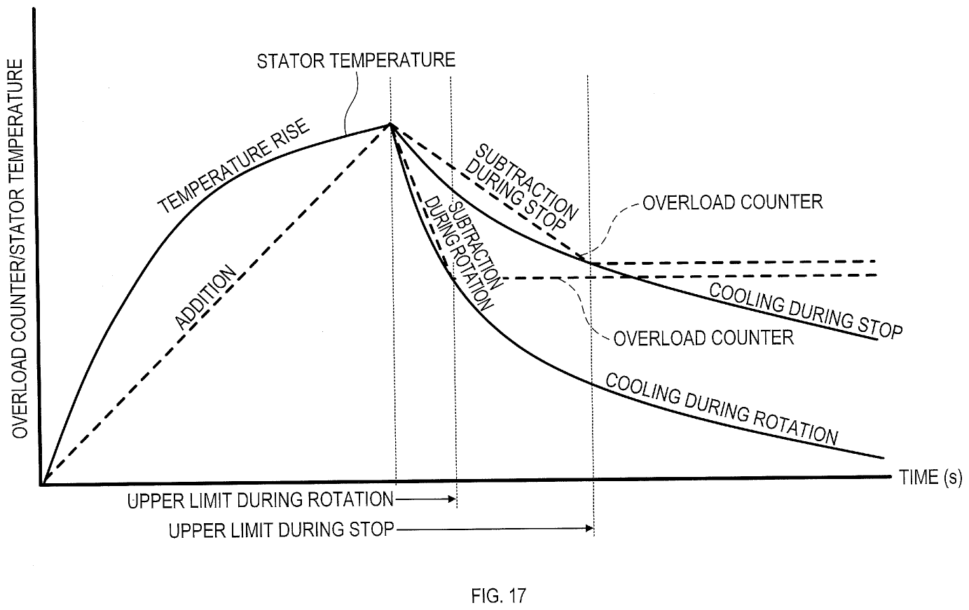

To address the problem, the first microcomputer 40 sets an upper limit for a subtraction time of the overload counter Co during the rotation of the motor 70 as illustrated in FIG. 17. In a case where the subtraction time reaches the upper limit, the first microcomputer 40 stops decreasing the overload counter Co to maintain the overload counter Co. In the present embodiment, the second counter threshold Tx corresponds to an example of the first time threshold of the summary of embodiments.

In S980, since the motor 70 stops, the first microcomputer 40 resets the motor drive counter Cd to 0, and proceeds to S990.

In S990, the first microcomputer 40 determines whether the overload counter Co is greater than 0. When determining that the overload counter Co is greater than 0 (S990: YES), the first microcomputer 40 proceeds to processing in S15. When determining that the overload counter Co is 0 or less (S990: NO), the first microcomputer 40 proceeds to S55.

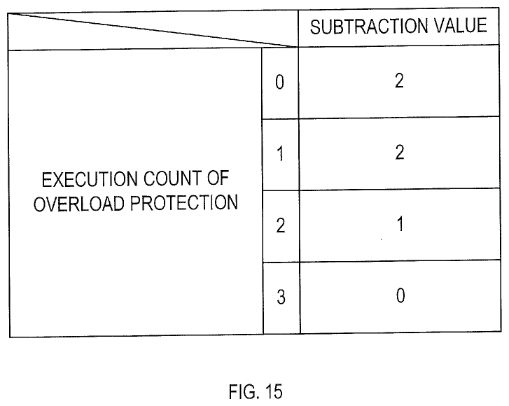

In S15, the first microcomputer 40 acquires a subtraction value corresponding to the execution count Nm from a second subtraction value table, and proceeds to S25. The first memory 42 stores the second subtraction value table. As illustrated in FIG. 15, the second subtraction value table shows a subtraction value corresponding to the execution count Nm. The subtraction value increases according to a decrease in the execution count Nm. In another embodiment, the first memory 42 may store a second subtraction rate table instead of the second subtraction value table. The second subtraction rate table shows a subtraction rate of the overload counter Co corresponding to the execution count Nm. The first microcomputer 40 may decrease the overload counter on the basis of a second subtraction rate.

In S25, the first microcomputer 40 determines whether the subtraction value is greater than 0. When determining that the subtraction value is greater than 0 (S25: YES), the first microcomputer 40 proceeds to S35. When determining that the subtraction value is 0 or less (S25: NO), the first microcomputer 40 proceeds to S55.

In S35, the first microcomputer 40 adds a fixed value to the motor stop counter Cs, and proceeds to S45. The motor stop counter Cs corresponds to a time elapsed from a time point of starting to decrease the overload counter Co during the stop of the motor 70.

In S45, the first microcomputer 40 determines whether the motor stop counter Cs is smaller than a third counter threshold Ty. When determining that the motor stop counter Cs is smaller than the third counter threshold Ty (S45: YES), the first microcomputer 40 proceeds to S65. When determining that the motor stop counter Cs is equal to or more than the third counter threshold Ty (S45: NO), the first microcomputer 40 proceeds to S55.

In S55, the first microcomputer 40 resets the subtraction value to 0, and proceeds to S65. As a result, when the time elapsed from the time point of starting to decrease the overload counter Co reaches the third counter threshold Ty during the stop of the motor 70, the decrease of the overload counter Co is stopped.

As illustrated in FIG. 16, when the motor 70 stops, the temperature of the motor 70 is somewhat rapidly reduced and then very slowly reduced. Therefore, when the overload counter Co continues to decrease during the stop of the motor 70, the overload counter Co can deviate from the stator temperature of the motor 70.

To address the problem, the first microcomputer 40 sets an upper limit for a subtraction time of the overload counter Co during the stop of the motor 70 as illustrated in FIG. 17. In a case where the subtraction time reaches the upper limit, the first microcomputer 40 stops decreasing the overload counter Co to maintain the overload counter Co. In the present embodiment, the third counter threshold Ty corresponds to an example of the second time threshold of the summary of embodiments.

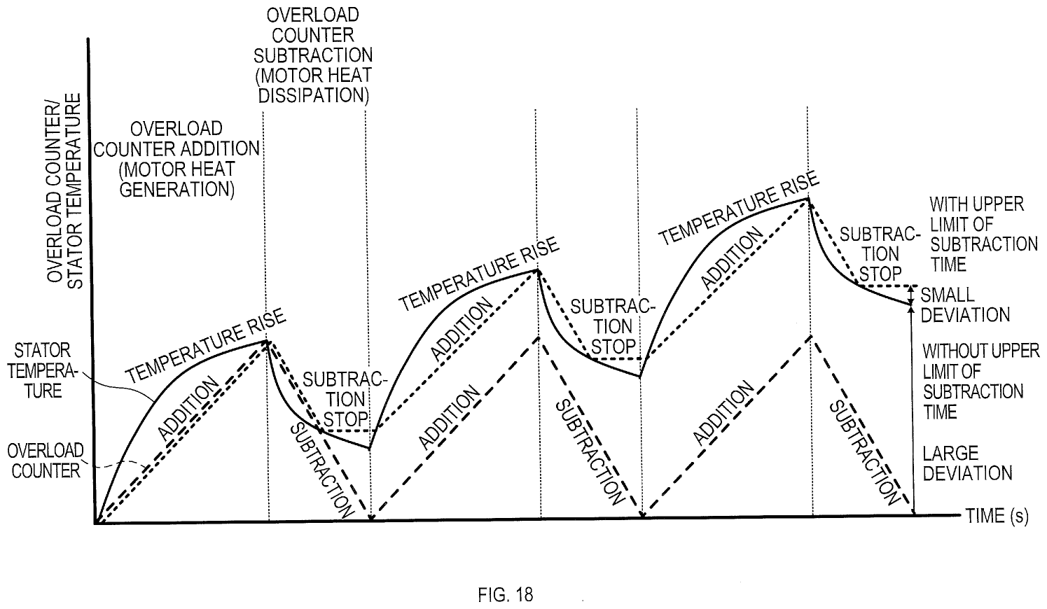

In FIG. 18, a solid line indicates a temporal change of the stator temperature of the motor 70. A dotted line indicates a temporal change of the overload counter Co in a case where the upper limit is set for the subtraction time during the rotation and stop of the motor 70. A broken line indicates a temporal change of the overload counter Co in a case where the upper limit is not set for the subtraction time during the rotation and stop of the motor 70. In a case where the upper limit is set for the subtraction time, the overload counter Co follows the stator temperature, and the deviation between the overload counter Co and the stator temperature is small. That is, the overload counter Co responds to the temperature of the motor 70 with high accuracy. On the other hand, in a case where the upper limit is not set for the subtraction time, the deviation between the overload counter Co and the stator temperature is large. That is, the overload counter Co does not accurately respond to the temperature of the motor 70.

In S65, the first microcomputer 40 determines whether the overload counter Co is equal to or more than the subtraction value. When determining that the overload counter Co is equal to or more than the subtraction value (S65: YES), the first microcomputer 40 proceeds to S75. When determining that the overload counter Co is less than the subtraction value (S65: NO), the first microcomputer 40 proceeds to S85.

In S75, the first microcomputer 40 subtracts the subtraction value from the overload counter Co, and ends this process.

In S85, the first microcomputer 40 resets the overload counter Co to 0, and ends this process. In the present embodiment, the overload counter Co is used as a value of 0 or more. In a case where the overload counter Co is less than the subtraction value, the first microcomputer 40 resets the overload counter Co to 0 so that the overload counter Co does not have a negative value.

### <3. Operation>

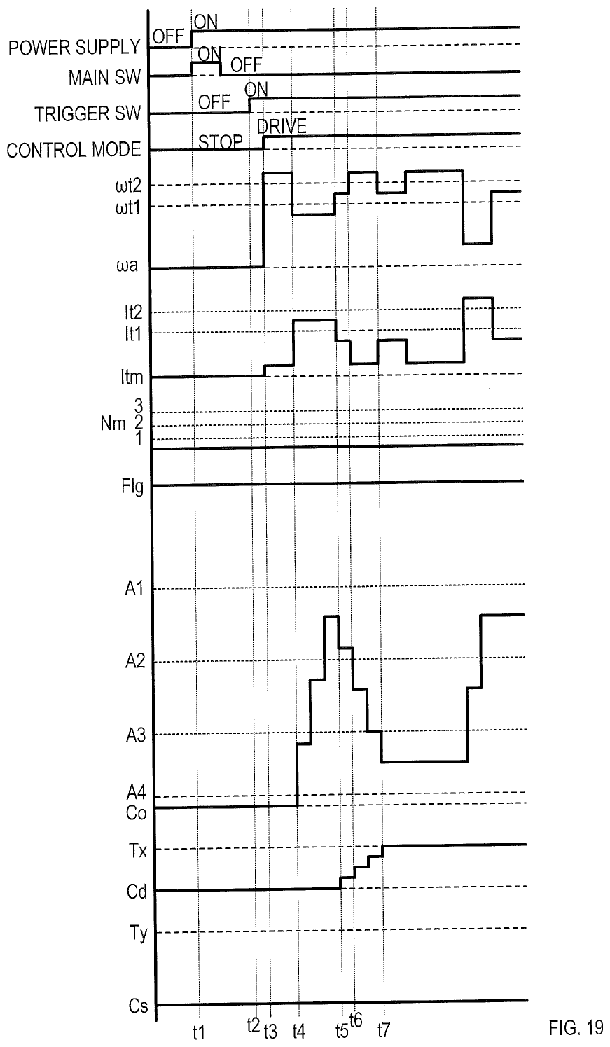

Temporal changes of various parameters during the rotation of the motor 70 will be described with reference to a time chart of FIG. 19.

At a time point t1, the main power supply switch 21 is pushed, and the first CPU 41 is powered ON. At a time point t2, the trigger switch 18 is turned ON. At a time point t3, the motor control mode is set to the drive mode. As a result, a line current flows through the motor 70, and the motor 70 starts to rotate.

At a time point t4, the line current value Itm increases as a user starts working with the electric work machine 1. At the time point t4, the actual rotational speed ωa decreases according to a load applied to the motor 70. Furthermore, at the time point t4, the line current value Itm becomes equal to or more than the first current threshold Ith1, and thus the overload counter Co starts to increase at an increase rate according to the line current value Itm. During a period from the time point t4 to a time point t5, the line current value Itm is equal to or more than the first current threshold Ith1, and the overload counter Co continues to increase. During the period from the time point t4 to the time point t5, the actual rotational speed ωa is less than the first speed threshold ωt1.

At the time point t5, the line current value Itm becomes less than the first current threshold Ith1, and the actual rotational speed ωa becomes equal to or more than the first speed threshold ωt1, so that the overload counter Co starts to decrease at a decrease rate according to the actual rotational speed ωa. The motor drive counter Cd also starts to increase. At a time point t6, the actual rotational speed ωa becomes equal to or more than the second speed threshold ωt2, so that the decrease rate of the overload counter Co increases. At a time point t7, the actual rotational speed ωa is equal to or more than the first speed threshold ωt1 and less than the second speed threshold ωt2. However, since the motor drive counter Cd reaches the second counter threshold Tx, the overload counter Co stops decreasing.

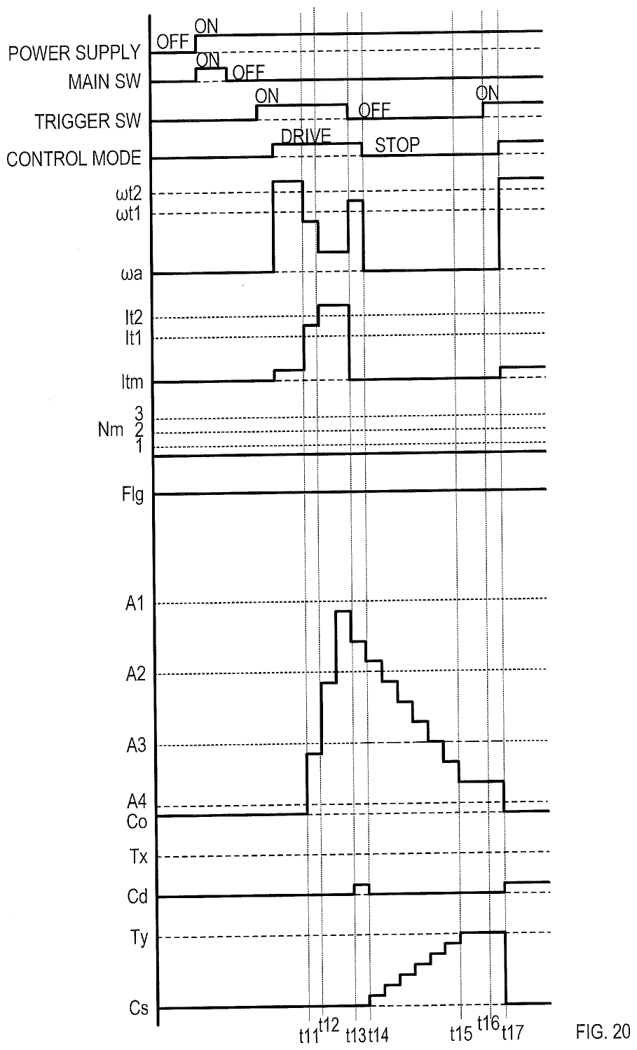

Next, temporal changes of various parameters during the inertial rotation and stop of the motor 70 will be described with reference to a time chart of FIG. 20.

At a time point t11, the line current value Itm increases and the actual rotational speed ωa decreases as a user starts working with the electric work machine 1. At the time point t11, the line current value Itm becomes equal to or more than the first current threshold Ith1, and thus the overload counter Co starts to increase at an increase rate according to the line current value Itm. At a time point t12, the line current value Itm becomes equal to or more than the second current threshold Ith2, so that the increase rate of the overload counter Co increases.

At a time point t13, the trigger switch 18 is turned OFF, and the line current value Itm becomes 0. During a period from the time point t13 to a time point t14, the motor 70 continues to rotate by inertia. At the time point t14, the motor 70 stops. At the time point t13, the actual rotational speed ωa becomes equal to or more than the first speed threshold ωt1, so that the overload counter Co starts to decrease at a decrease rate according to the actual rotational speed ωa, and the motor drive counter Cd starts to increase. At the time point t14, since the motor 70 stops, the motor drive counter Cd is cleared.

At the time point t14, since the motor 70 stops, the overload counter Co continues to decrease at a decrease rate according to the execution count Nm and the motor stop counter Cs starts to increase.

At a time point t15, the motor stop counter Cs reaches the third counter threshold Ty, so that the overload counter Co stops decreasing. At a time point t16, the trigger switch 18 is turned ON. At a time point t17, the motor 70 starts to rotate, so that the motor stop counter Cs is cleared.

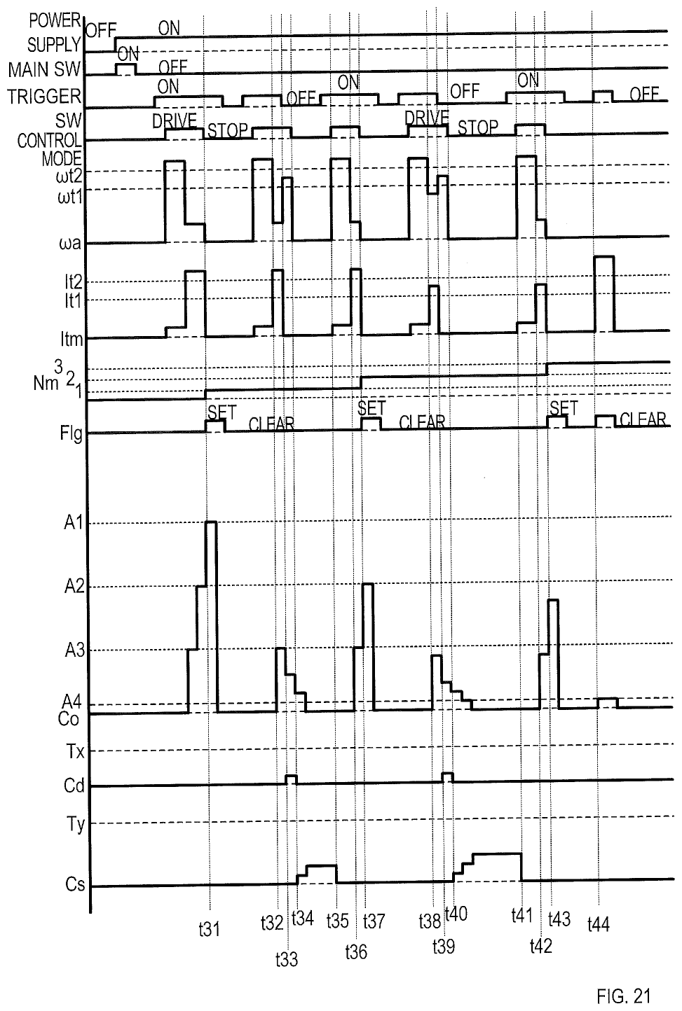

Next, a change in the decrease rate of the overload counter Co according to the execution count Nm will be described with reference to a time chart of FIG. 21.

At a time point t31, the overload counter Co becomes equal to or more than the first counter threshold Ta, so that the overload protection flag Flg is set, and the motor 70 stops. At this time, the 0th threshold A1 is set for the first counter threshold Ta. Since the overload protection is executed, the execution count Nm is changed from 0 to 1. The overload counter Co is reset to 0, and the overload protection flag Flg is cleared. Furthermore, the first threshold A2 is set for the first counter threshold Ta.

At a time point t32, the line current value Itm becomes equal to or more than the first current threshold Ith1 along with the work using the electric work machine 1, and the overload counter Co increases at an increase rate according to the line current value Itm. At a time point t33, the trigger switch 18 is turned OFF. During a period from the time point t33 to a time point t34, the motor 70 rotates by inertia, and the actual rotational speed ωa is equal to or more than the first speed threshold ωt1, so that the overload counter Co decreases at a decrease rate according to the actual rotational speed ωa, and the motor drive counter Cd increases.

At the time point t34, the motor 70 stops, and the motor drive counter Cd is cleared. Since the motor 70 stops, the overload counter Co starts to decrease at a decrease rate according to the execution count Nm “1”, and the motor stop counter Cs starts to increase. In response to the overload counter Co becoming 0, the decrease is stopped.

At a time point t35, the motor 70 starts to rotate, so that the motor stop counter Cs is cleared. Although the actual rotational speed ωa is equal to or more than the second speed threshold ωt2, the overload counter Co is 0, and thus the overload counter Co does not decrease.

At a time point t36, the line current value Itm becomes equal to or more than the second current threshold Ith2, and thus the overload counter Co starts to increase at an increase rate according to the line current value Itm. At a time point t37, the overload counter Co becomes equal to or more than the first counter threshold Ta, so that the overload protection flag Flg is set, and the motor 70 stops. Since the overload protection is executed, the execution count Nm is changed from 1 to 2. The overload counter Co is reset to 0, and the overload protection flag Flg is cleared. Furthermore, the second threshold A3 is set for the first counter threshold Ta.

At a time point t38, the line current value Itm becomes equal to or more than the first current threshold Ith1 along with the work using the electric work machine 1, and the overload counter Co increases at an increase rate according to the line current value Itm. At a time point t39, the trigger switch 18 is turned OFF. During a period from the time point t39 to a time point t40, the motor 70 rotates by inertia, and the actual rotational speed ωa is equal to or more than the first speed threshold ωt1, so that the overload counter Co decreases at a decrease rate according to the actual rotational speed ωa, and the motor drive counter Cd increases.

At the time point t40, the motor 70 stops, and the motor drive counter Cd is cleared. Since the motor 70 stops, the overload counter Co starts to decrease at a decrease rate according to the execution count Nm “2”, and the motor stop counter Cs starts to increase. In response to the overload counter Co becoming 0, the decrease of the overload counter Co is stopped.

At a time point t41, the motor 70 starts to rotate, so that the motor stop counter Cs is cleared. Although the actual rotational speed ωa is equal to or more than the second speed threshold ωt2, the overload counter Co is 0, and thus the overload counter Co does not decrease.

At a time point t42, the line current value Itm becomes equal to or more than the first current threshold Ith1, and the overload counter Co increases at an increase rate according to the line current value Itm. At a time point t43, the overload counter Co becomes equal to or more than the first counter threshold Ta, so that the overload protection flag Flg is set, and the motor 70 stops. Since the overload protection is executed, the execution count Nm is changed from 2 to 3. The overload counter Co is reset to 0, and the overload protection flag Flg is cleared. Furthermore, the third threshold A4 is set for the first counter threshold Ta.

At a time point t44, the line current value Itm becomes equal to or more than the second current threshold Ith2, and the overload counter Co increases at an increase rate according to the line current value Itm. The overload counter Co becomes equal to or more than the first counter threshold Ta, the overload protection flag Flg is set, and the motor 70 stops. Since the execution count Nm exceeds 3 times, the motor 70 is not driven even if the trigger switch 18 is turned ON after the time point t44.

### <4. Effects>

According to the first embodiment described in detail above, the following effects are obtained.

(1) The overload counter Co is increased on the basis of the line current value Itm and decreased on the basis of the actual rotational speed ωa of the motor 70. Therefore, the overload counter Co is decreased on the basis of the actual rotational speed ωa even during the inertial rotation of the motor 70. Hence, the overload counter Co responds to the actual temperature of the motor 70 with high accuracy. As a result, in the electric work machine 1, the motor 70 can be appropriately protected.

(2) The reduction amount of the temperature of the motor 70 changes depending on the actual rotational speed ωa of the motor 70. By changing the decrease rate of the overload counter according to the actual rotational speed ωa, the overload counter Co is enabled to respond to the actual temperature of the motor 70 with higher accuracy.

(3) The higher the actual rotational speed ωa of the motor 70, the greater the reduction amount of the temperature of the motor 70. By increasing the decrease rate of the overload counter Co according to an increase in the actual rotational speed ωa, the overload counter Co is enabled to respond to the actual temperature of the motor 70 with higher accuracy.

(4) In a case where the type of the battery 83 is different, the line current value Itm is different even when the actual rotational speed ωa of the motor 70 is the same. As a result, the reduction amount of the temperature of the motor 70 is different. By changing the subtraction value according to the type of the battery 83, the overload counter Co is enabled to respond to the actual temperature of the motor 70 with higher accuracy.

(5) In a case where the internal resistance of the battery 83 is different, the line current value Itm is different even when the actual rotational speed ωa of the motor 70 is the same. As a result, the reduction amount of the temperature of the motor 70 is different. By changing the subtraction value according to the internal resistance of the battery 83, the overload counter Co is enabled to respond to the actual temperature of the motor 70 with higher accuracy.

(6) When the deterioration of the battery 83 progresses, the internal resistance of the battery 83 increases. When the deterioration of the battery 83 progresses, the battery pack 8 reduces the protection threshold in order to protect the battery 83 at an early stage. Therefore, by changing the subtraction value according to the protection threshold, the overload counter Co is enabled to respond to the actual temperature of the motor 70 with higher accuracy.

(7) The execution count Nm corresponds to the accumulation of the temperature of the motor 70. Therefore, by decreasing the decrease rate of the overload counter Co according to an increase in the execution count Nm, the overload counter Co is enabled to respond to the actual temperature of the motor 70 with higher accuracy.

(8) The actual temperature of the motor 70 is rapidly reduced to some extent and then gradually reduced. Therefore, when the overload counter Co continues to be decreased during the rotation of the motor 70, the overload counter Co deviates from the actual temperature of the motor 70. Thus, the upper limit is set for the subtraction time during the rotation of the motor 70, and the decrease of the overload counter Co is stopped when the subtraction time reaches the upper limit. As a result, the overload counter Co can be inhibited from deviating from the actual temperature of the motor 70.

(9) When the overload counter Co continues to be decreased during the stop of the motor 70, the overload counter Co deviates from the actual temperature of the motor 70. Thus, the upper limit is set for the subtraction time during the stop of the motor 70, and the decrease of the overload counter Co is stopped when the subtraction time reaches the upper limit. As a result, the overload counter Co can be inhibited from deviating from the actual temperature of the motor 70.

### Second Exemplary Embodiment of Summary of Embodiments

<1. Difference from First Embodiment>

Since the second embodiment has a basic configuration similar to that of the first embodiment, differences will be described below. Note that the same reference numerals as those in the first embodiment indicate the same components, and reference is made to the preceding description.

In the first embodiment, the electric work machine 1 includes the controller 30A. The second embodiment differs from the first embodiment in that the electric work machine 1 includes a controller 30B instead of the controller 30A.

In the first embodiment, the first speed threshold ωt1 and the second speed threshold ωt2 are constant values. The second embodiment differs from the first embodiment in that the first microcomputer 40 calculates the first speed threshold ωt1 and the second speed threshold ωt2 on the basis of an input voltage value Vmot of the motor 70. The input voltage value Vmot corresponds to the magnitude of a voltage input to the motor 70.

In a case where the motor 70 is subjected to constant rotation control, the rotational speed is maintained even when a large load is applied to the motor 70. Therefore, in a case where the first speed threshold ωt1 and the second speed threshold ωt2 are constant, the line current value Itm may be greater than the first current threshold Ith1, and the rotational speed may be greater than the first speed threshold ωt1 when a heavy load is applied to the motor 70. As a result, the decrease and increase of the overload counter Co may occur at the same time, the overload counter Co may deviate from the temperature of the motor 70, and the motor 70 may not be able to be protected at an appropriate timing.

To address the problem, in the second embodiment, the first microcomputer 40 decreases the overload counter Co only when a difference ΔV obtained by subtracting an induced voltage value Vf from the input voltage value Vmot of the motor 70 is less than a predetermined value (for example, 3.6 V). In a case where a heavy load is applied to the motor 70 during the constant rotation control, the input voltage value Vmot increases in order to maintain a constant rotational speed of the motor 70. The induced voltage value Vf corresponds to the magnitude of a voltage generated in the winding by the rotation of the motor 70, and is proportional to the rotational speed of the motor 70. Thus, in the constant rotation control, the difference ΔV increases according to an increase in the load. Therefore, by not decreasing the overload counter Co when the difference ΔV is equal to or more than the predetermined value, an inappropriate decrease of the overload counter Co is inhibited. In the second embodiment, the first microcomputer 40 calculates the first speed threshold ωt1 and the second speed threshold ωt2 on the basis of the input voltage value Vmot so that the overload counter Co is decreased only when the difference ΔV is less than the predetermined value.

Furthermore, in the first embodiment, the subtraction value acquired from the first or second subtraction value table is subtracted from the overload counter Co. On the other hand, the second embodiment differs from the first embodiment in that the subtraction value acquired from the first or second subtraction value table is corrected on the basis of the overload counter Co and the corrected subtraction value is subtracted from the overload counter Co.

The motor temperature (specifically, the stator temperature) is reduced more rapidly as a temperature difference between an ambient temperature and the motor temperature is greater. The temperature difference is greater as the motor temperature is higher. Therefore, the higher the motor temperature, the greater the reduction rate of the motor temperature. Thus, when the reduction rate of the motor temperature is constant, the overload counter Co may become greater than the actual temperature of the motor 70. As a result, the first microcomputer 40 may stop the motor 70 at an unnecessarily early stage on the basis of the overload counter Co. To address the problem, in the second embodiment, in order to further inhibit the deviation between the overload counter Co and the actual temperature of the motor 70, the first microcomputer 40 corrects the subtraction value so that the decrease rate increases according to an increase in the overload counter Co.

### <2. Configuration of Controller>

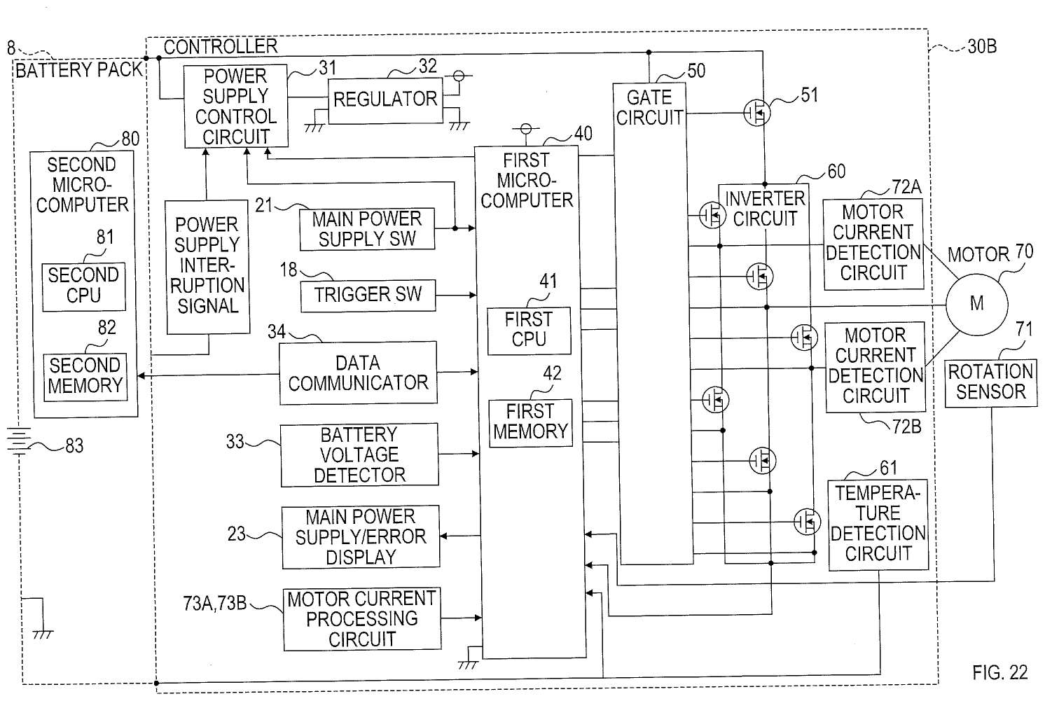

A configuration of the controller 30B according to the second embodiment will be described with reference to FIG. 22. The controller 30B does not include the current detection circuit 62. Instead, the controller 30B includes motor current detection circuits 72A and 72B and motor current processing circuits 73A and 73B. The motor current detection circuit 72A is disposed in one-phase winding of the motor 70, detects the line current value Itm flowing through the one-phase winding, and outputs the detected line current value Itm to the motor current processing circuit 73A. The motor current detection circuit 72B is disposed in another-phase winding of the motor 70, detects the line current value Itm flowing through the other-phase winding, and outputs the detected line current value Itm to the motor current processing circuit 73B.

The motor current processing circuits 73A and 73B perform a filter process and an amplification process on the input line current values Itm, and output the processed line current values Itm to the first microcomputer 40. As a result, the first microcomputer 40 acquires the line current values Itm of two phases out of the three phases. The total value of the line current values Itm of the three phases is constant. Therefore, the first microcomputer 40 can acquire the line current value Itm of the remaining one phase by acquiring the line current values Itm of the two phases.

### <3. Overload Counter Subtraction Process>

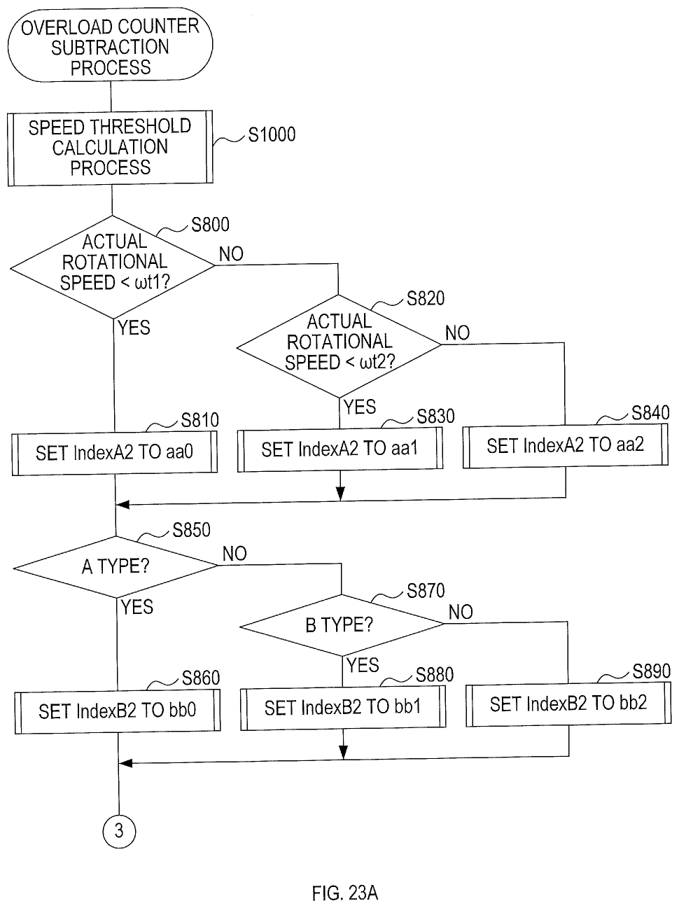

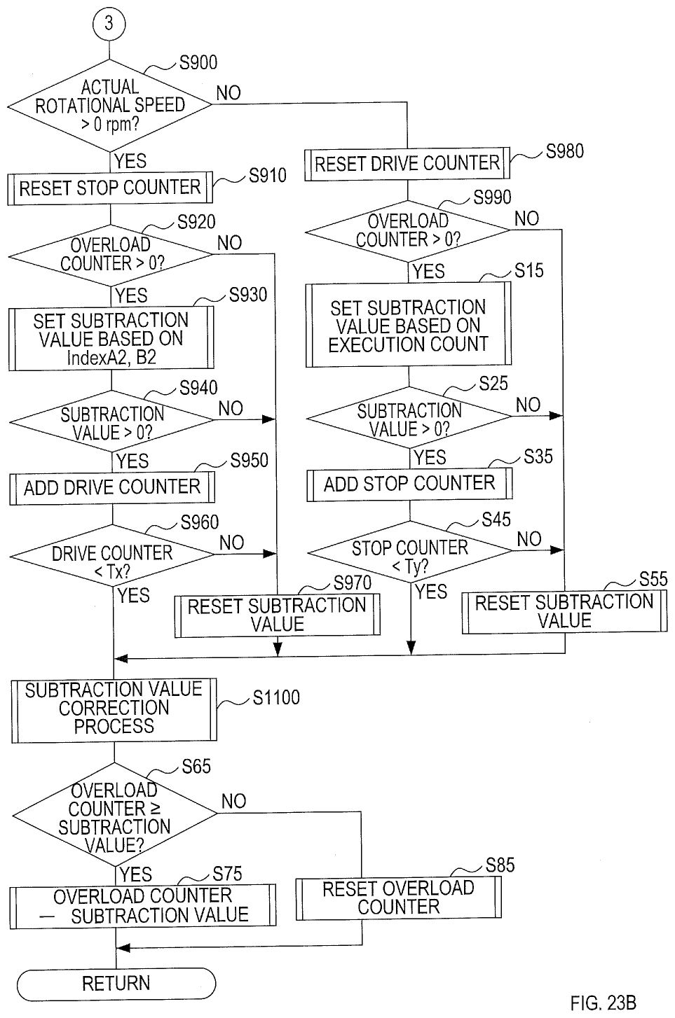

The overload counter subtraction process executed by the first microcomputer 40 in S590 will be described with reference to FIGS. 23A and 23B.

First, in S1000, the first microcomputer 40 executes a speed threshold calculation process to calculate the first speed threshold ωt1 and the second speed threshold ωt2. The details of the speed threshold calculation process will be described later.

Subsequently, in S800 to S990 and S15 to S55, the first microcomputer 40 executes processes similar to S800 to S990 and S15 to S55 in the first embodiment.

Subsequently, in S1100, the first microcomputer 40 executes a subtraction value correction process to correct the subtraction value acquired from the first or second subtraction value table. The details of the subtraction value correction process will be described later.

Subsequently, in S65 to S85, the first microcomputer 40 executes processes similar to S65 to S85 in the first embodiment.

That is, in the overload counter subtraction process according to the second embodiment, the first microcomputer 40 executes S1000 and S1100 in addition to the overload counter subtraction process according to the first embodiment.

### <3-1. Speed Threshold Calculation Process>

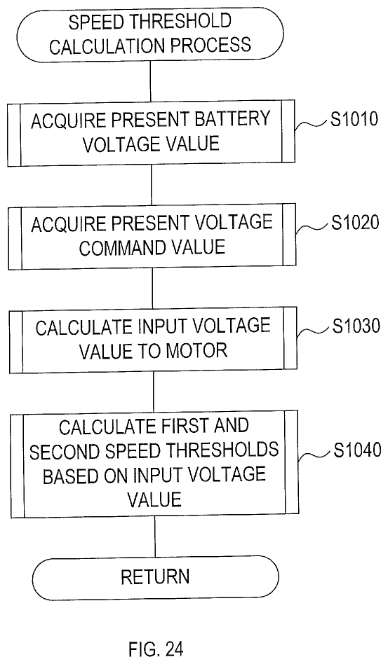

The speed threshold calculation process executed by the first microcomputer 40 in S1000 will be described with reference to FIG. 24.

First, in S1010, the first microcomputer 40 acquires the present battery voltage value Vbat detected by the battery voltage detector 33.

Subsequently, in S1020, the first microcomputer 40 acquires the present voltage command value.

Subsequently, in S1030, the first microcomputer 40 calculates the input voltage value Vmot on the basis of the battery voltage value Vbat acquired in S1010 and the voltage command value acquired in S1020. Specifically, in the case of PWM-controlling the motor 70, the first microcomputer 40 calculates the input voltage value Vmot on the basis of the battery voltage value Vbat×the voltage command value (specifically, the output duty ratio) (%)÷100. Alternatively, in the case of vector-controlling the motor 70, the first microcomputer 40 converts a two-phase voltage command value in a rotational coordinate system into a three-phase voltage command value in a fixed coordinate system, and sets the three-phase voltage command value as the input voltage value Vmot.

Subsequently, in S1040, the first microcomputer 40 calculates the first speed threshold ωt1 and the second speed threshold ωt2 on the basis of the input voltage value Vmot calculated in S1030. Specifically, the first microcomputer 40 calculates the first speed threshold ωt1 and the second speed threshold ωt2 to be greater according to an increase in the input voltage value Vmot. For example, the first microcomputer 40 multiplies the input voltage value Vmot by a first coefficient K1 to calculate the first speed threshold ωt1. The first microcomputer 40 also multiplies the input voltage value Vmot by a second coefficient K2 to calculate the second speed threshold ωt2. The first coefficient K1 and the second coefficient K2 are positive values, and the second coefficient K2 is greater than the first coefficient K1.

As a result, as the input voltage value Vmot is greater, the decrease of the overload counter Co is inhibited. That is, in a case where a heavy load is applied to the motor 70 and the rotational speed is maintained by increasing the input voltage Vmot, the decrease of the overload counter Co is inhibited.

### <3-2. Subtraction Value Correction Process>

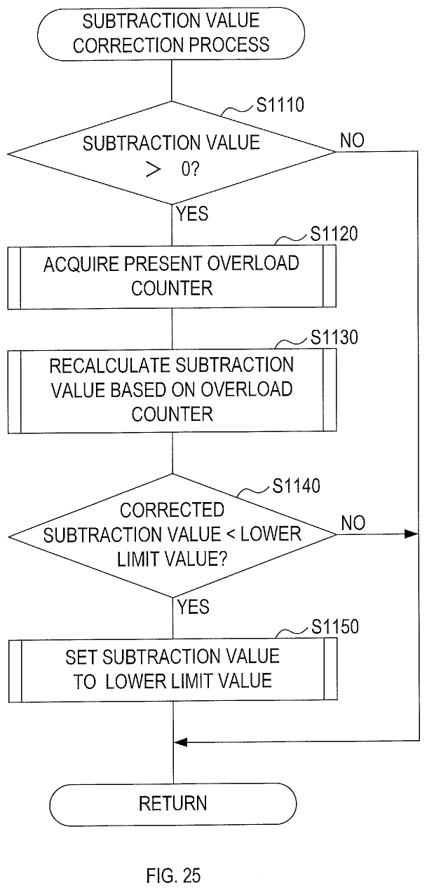

The subtraction value correction process executed by the first microcomputer 40 in S1100 will be described with reference to FIG. 25.

First, in S1110, the first microcomputer 40 determines whether the subtraction value acquired from the first or second subtraction value table is greater than 0. When determining that the subtraction value is greater than 0 (S1110: YES), the first microcomputer 40 proceeds to S1120. When determining that the subtraction value is 0 (S1110: NO), the first microcomputer 40 ends this process without correcting the subtraction value.

In S1120, the first microcomputer 40 acquires the present overload counter Co.

In S1130, the first microcomputer 40 recalculates the subtraction value on the basis of the overload counter Co. Specifically, the first microcomputer 40 calculates the subtraction value to be greater as the overload counter Co is greater. For example, the first microcomputer 40 calculates a correction coefficient Kn by dividing the present overload counter Co by a reference counter value. The reference counter value is a constant and is less than the first counter threshold Ta. The correction coefficient Kn is a value of 1 or less. For example, in a case where the first counter threshold Ta is 10000 and the reference counter value is 80000, the correction coefficient Kn is calculated to be 1.125. In this case, the correction coefficient Kn=1.

The first microcomputer 40 multiplies the present subtraction value by the correction coefficient Kn to calculate the corrected subtraction value. The correction coefficient Kn is a value close to 1 in a case where the overload counter Co is large, and is a value close to 0 in a case where the overload counter Co is small. As a result, the subtraction value becomes large in a case where the value of the overload counter Co is large, and the subtraction value becomes small in a case where the overload counter Co is small.

Subsequently, in S1140, the first microcomputer 40 determines whether the subtraction value calculated in S1130 is less than a lower limit value. The lower limit value is a minimum value of the subtraction value and is set in advance. When determining that the subtraction value is less than the lower limit value (S1140: YES), the first microcomputer 40 proceeds to S1150. When determining that the subtraction value is equal to or more than the lower limit value (S1140: NO), the first microcomputer 40 ends this process.

In S1150, the first microcomputer 40 sets the subtraction value to the lower limit value. The first microcomputer 40 sets the subtraction value the lower limit value in a case where the subtraction value is less than the lower limit value so that the overload counter decreases to a certain extent.

### <4. Operation>

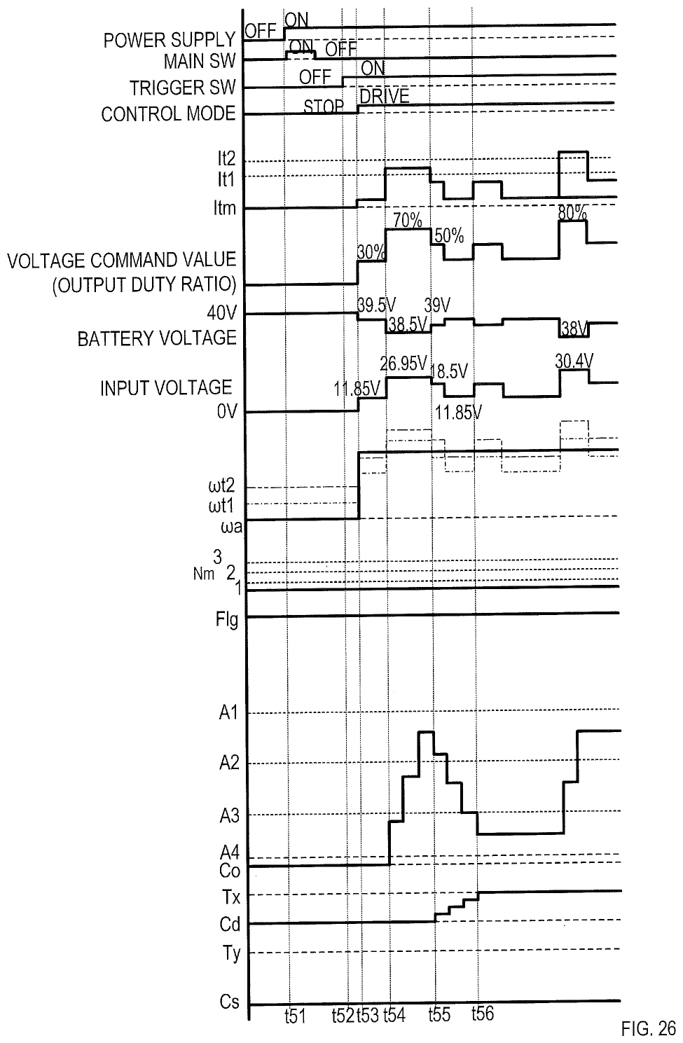

Temporal changes of various parameters during the rotation of the motor 70 will be described with reference to a time chart of FIG. 26.

At a time point t51, the main power supply switch 21 is pushed, and the first CPU 41 is powered ON. At a time point t52, the trigger switch 18 is turned ON. At a time point t53, the filter process of an ON signal of the trigger switch 18 is finished, and the motor control mode is set to the drive mode. As a result, a line current flows through the motor 70. The constant rotation control of the motor 70 is started so that the actual rotational speed ωa becomes the target rotational speed ωT. At this time, the target rotational speed ωT and the actual rotational speed ωa are smaller than the first speed threshold ωt1 and the second speed threshold ωt2. The line current value Itm is less than the first current threshold Ith1.

At a time point t54, a user starts working with the electric work machine 1, so that a load applied to the motor 70 increases and the line current value Itm increases. Furthermore, in order to maintain the actual rotational speed ωa at the target rotational speed ωT, the voltage command value and the input voltage value Vmot increase according to the increase in the load. As a result, the first speed threshold ωt1 and the second speed threshold ωt2 become greater than the target rotational speed ωT. In addition, as the load increases, the voltage drop amount increases, and the battery voltage value Vbat decreases.

At the time point t54, the line current value Itm is equal to or more than the first current threshold Ith1 and less than the second current threshold Ith2, so that the overload counter Co is increased. However, since the first speed threshold ωt1 and the second speed threshold ωt2 are greater than the target rotational speed ωT, the overload counter Co is not decreased.

At a time point t55, the load applied to the motor 70 decreases, and the line current value Itm becomes smaller than the first current threshold Ith1. Furthermore, in order to maintain the actual rotational speed ωa at the target rotational speed ωT, the voltage command value and the input voltage value Vmot decrease according to the decrease in the load. As a result, the first speed threshold ωt1 and the second speed threshold ωt2 become small. The first speed threshold ωt1 is smaller than the target rotational speed ωT, and the second speed threshold ωt2 is greater than the target rotational speed ωT.

Therefore, the subtraction value according to the overload counter Co is subtracted from the overload counter Co. Furthermore, as the overload counter Co starts decreasing, the motor drive counter Cd starts increasing. At a time point t56, the motor drive counter Cd reaches the second counter threshold Tx, so that the overload counter Co stops decreasing.

### <5. Effects>

According to the second embodiment described in detail above, the following effects are obtained in addition to the effects (1) to (9) of the first embodiment.

(10) The first speed threshold ωt1 and the second speed threshold ωt2 increase according to an increase in the input voltage Vmot. As a result, in a case where a heavy load is applied to the motor 70, the addition value is added to the overload counter Co, but the subtraction value is not subtracted from the overload counter Co. Therefore, in a case where a heavy load is applied to the motor 70 during the constant rotation control, it is possible to inhibit an inappropriate decrease of the overload counter Co.

(11) The decrease rate of the overload counter Co increases according to an increase in the value of the overload counter Co. As a result, the deviation between the value of the overload counter Co and the motor temperature is further reduced. Consequently, the motor 70 can be appropriately protected.

### OTHER EMBODIMENTS

Although the exemplary embodiments of the summary of embodiments have been described above, the summary of embodiments is not limited to the above-described embodiments, and various modifications can be made.

(a) In the above embodiments, the electric work machine 1 is a chain saw, but the electric work machine 1 of the summary of embodiments is not limited to the chain saw. The electric work machine 1 may be an electric tool other than the chain saw, or may be a gardening tool. The electric tool may be, for example, a driver drill, an impact driver, a circular saw, or the like. The gardening tool may be, for example, a mower, a trimmer, or the like.

(b) In the above embodiments, the electric work machine 1 includes the battery attachment part 10, but may include a power cord instead of or in addition to the battery attachment part 10. That is, the electric work machine 1 may receive a power from an external power supply such as a commercial power supply by connecting the power cord to the external power supply. In this case, the external power supply corresponds to an example of the power supply of the summary of embodiments.

(c) In the above embodiments, the electric work machine 1 includes the motor 70 that is a brushless motor and the rotation sensor 71, but may include the motor 70 that is a brushless motor without including the rotation sensor 71. In a case where the electric work machine 1 does not include the rotation sensor 71, the first microcomputer 40 may detect the position of the rotor on the basis of an induced voltage induced in the winding of the motor 70 and estimate the rotational speed. The first microcomputer 40 may use the estimated rotational speed instead of the actual rotational speed calculated from the position signal.

(d) In the above embodiments, the subtraction value increases according to an increase in the actual rotational speed ωa during the rotation of the motor 70, but the summary of embodiments is not limited thereto. Depending on the type of the electric work machine 1, the motor 70 may be braked in a case where the actual rotational speed ωa of the motor 70 exceeds a predetermined speed. When the motor 70 is braked, heat is generated by braking. Thus, the reduction rate of the temperature of the motor 70 is reduced. To address the problem, in a case where the actual rotational speed ωa is equal to or less than the predetermined speed, the subtraction value may be increased according to an increase in the actual rotational speed ωa, and in a case where the actual rotational speed ωa exceeds the predetermined speed, the subtraction value may be decreased.

(e) In the above embodiments, the first microcomputer 40 changes the addition value according to the type of the battery 83 and the line current value Itm, but the summary of embodiments is not limited thereto. The first microcomputer 40 may change the addition value according to only the line current value Itm, or according to only the type of the battery 83. The first microcomputer 40 may make the addition value constant regardless of the type of the battery 83 and the line current value.

(f) In the above embodiments, the first microcomputer 40 changes the first counter threshold Ta according to the execution count Nm, but the summary of embodiments is not limited thereto. The first microcomputer 40 may make the first counter threshold Ta constant regardless of the execution count Nm.

(g) In the above embodiments, the first microcomputer 40 changes the subtraction value according to the type of the battery 83 and the actual rotational speed ωa during the rotation of the motor 70, but the summary of embodiments is not limited thereto. The first microcomputer 40 may change the subtraction value according to only the actual rotational speed ωa, or according to only the type of the battery 83. The first microcomputer 40 may make the subtraction value constant regardless of the type of the battery 83 and the actual rotational speed ωa.

(h) In the above embodiments, the first microcomputer 40 changes the subtraction value according to the execution count Nm during the stop of the motor 70, but the summary of embodiments is not limited thereto. The first microcomputer 40 may make the subtraction value constant regardless of the execution count Nm during the stop of the motor 70.

(i) In the second embodiment, the first microcomputer 40 calculates the first speed threshold ωt1 and the second speed threshold ωt2 on the basis of the input voltage value Vmot, but may calculate the first speed threshold ωt1 and the second speed threshold ωt2 on the basis of the power supply voltage value (for example, the battery voltage value Vbat) or the voltage command value. Specifically, the first microcomputer 40 may calculate the first speed threshold ωt1 and the second speed threshold ωt2 to be greater according to an increase in the power supply voltage value. Alternatively, the first microcomputer 40 may calculate the first speed threshold ωt1 and the second speed threshold ωt2 to be greater according to an increase in the voltage command value.

(j) The electric work machine 1 according to the first embodiment may include the controller 30B instead of the controller 30A. In this case, the first microcomputer 40 may use the detected line current value Itm instead of estimating the line current value Itm. The electric work machine 1 according to the second embodiment may include the controller 30A instead of the controller 30B. In this case, the first microcomputer 40 may estimate the line current value Itm.

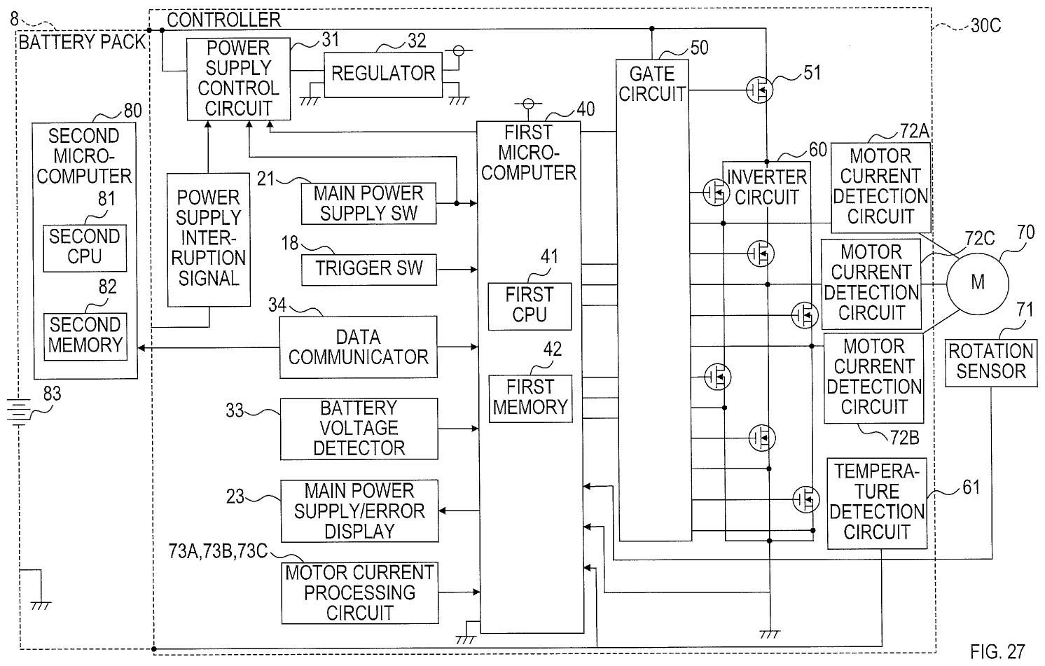

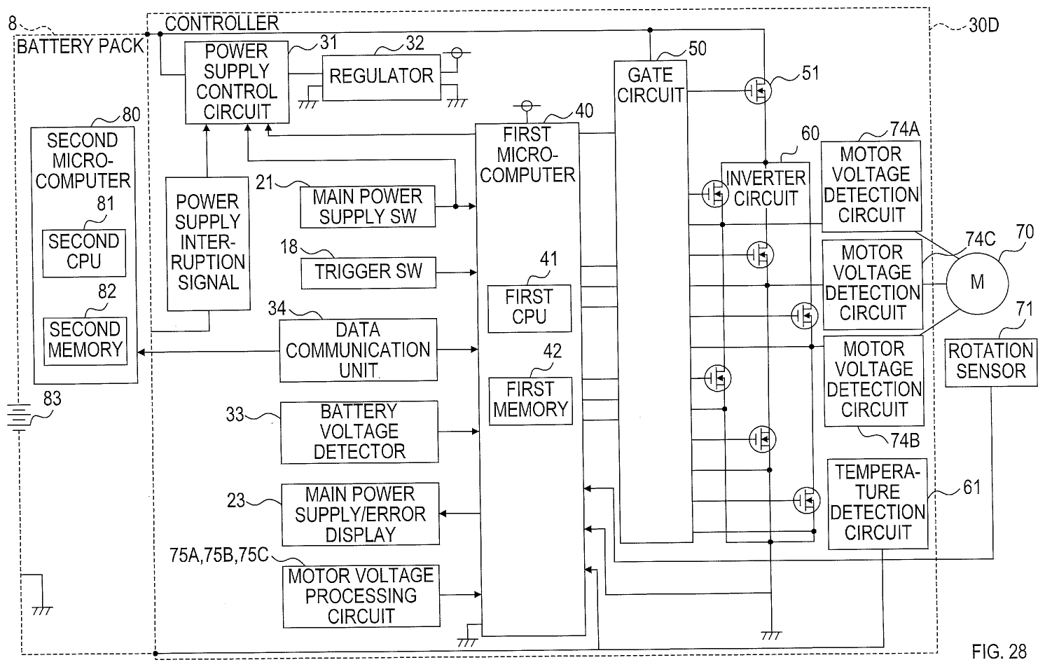

(k) The electric work machine 1 according to the first and second embodiments may include a controller 30C illustrated in FIG. 27 or a controller 30D illustrated in FIG. 28 instead of the controllers 30A and 30B. The controller 30C includes a motor current detection circuit 72C and a motor current processing circuit 73C in addition to the configuration of the controller 30B. That is, the controller 30C includes the motor current detection circuits 72A, 72B, and 72C disposed in the respective three-phase windings, and the corresponding motor current processing circuits 73A, 73B, and 73C.

The controller 30D does not include the current detection circuit 62 as compared with the controller 30A. Instead, the controller 30D includes motor voltage detection circuits 74A, 74B, and 74C and motor voltage processing circuits 75A, 75B, and 75C. The motor voltage detection circuits 74A, 74B, and 74C are disposed in the respective three-phase windings, detect the input voltage values Vmot of the respective phases, and output the detected input voltage values Vmot to the motor voltage processing circuits 75A, 75B, and 75C. The motor voltage processing circuits 75A, 75B, and 75C perform a filter process and an amplification process on the input voltage values Vmot, and output the processed input voltage values Vmot to the first microcomputer 40. In this case, the first microcomputer 40 may use the detected input voltage value Vmot instead of estimating the input voltage value Vmot. The first microcomputer 40 may also estimate the line current value Itm from the resistance of the winding and the input voltage value Vmot. In the present embodiment, the motor voltage detection circuits 74A, 74B, and 74C correspond to an example of the voltage detection circuit of the summary of embodiments.

(1) A plurality of functions of one component in the above embodiments may be performed by a plurality of components, or one function of one component may be performed by a plurality of components. A plurality of functions of a plurality of components may be realized by one component, or one function performed by a plurality of components may be performed by one component. The configuration of the above embodiments may be partially omitted. At least a part of the configuration of one of the above embodiments may be added to or replaced with the configuration of another embodiment.

What is claimed is:

1. A chain saw comprising:
a motor configured (i) to receive a power from a battery included in a battery pack (ii) to be driven;
a current detection circuit configured to detect a power supply current value, the power supply current value corresponding to a magnitude of a current supplied from the battery to the motor;
a rotation sensor configured to output a position signal indicating a rotational position of the motor; and
a microcomputer programmed to:
calculate a line current value based on the power supply current value detected by the current detection circuit, the line current value corresponding to a magnitude of a current flowing through the motor;
calculate an actual rotational speed of the motor based on the position signal output by the rotation sensor;
add an addition value to an overload counter based on the line current value being greater than a current threshold;
subtract a subtraction value from the overload counter based on the actual rotational speed being greater than a speed threshold;
(i) stop the motor and (ii) increase a first count based on the overload counter being equal to or more than a counter threshold;
increase the subtraction value according to an increase in the actual rotational speed based on the actual rotational speed being greater than 0; and
decrease the subtraction value according to an increase in the first count based on the actual rotational speed being less than 0.

2. An electric work machine comprising:
a motor configured to receive a power from a power supply to be driven; and
a first control circuit configured to:
acquire or estimate a line current value, the line current value corresponding to a magnitude of a current flowing through the motor;
calculate a rotational speed of the motor;
increase a first counter based on the line current value acquired or estimated being greater than a current threshold;
decrease the first counter based on the rotational speed calculated being greater than a speed threshold; and
stop the motor based on the first counter exceeding a first threshold.

3. The electric work machine according to claim 2, wherein
the first control circuit is configured to change a decrease rate of the first counter according to the rotational speed calculated by the first control circuit.

4. The electric work machine according to claim 3, wherein
the first control circuit is configured to increase the decrease rate according to an increase in the rotational speed calculated by the first control circuit.

5. The electric work machine according to claim 2, wherein
the power supply includes a battery pack connected to the electric work machine,
the battery pack includes a first battery or a second battery,
the electric work machine further includes a memory devise storing first correspondence data and second correspondence data, the first correspondence data and the second correspondence data each indicating a correspondence relation between the rotational speed and a decrease rate of the first counter, and the first correspondence data being different from the second correspondence data, and
the first control circuit is configured to:
select the first correspondence data based on the battery pack including the first battery;
select the second correspondence data based on the battery pack including the second battery; and
decrease the first counter based on the first correspondence data selected or the second correspondence data selected.

6. The electric work machine according to claim 5, wherein
the first battery has a first internal resistance, and
the second battery has a second internal resistance different from the first internal resistance.

7. The electric work machine according to claim 5, wherein
the battery pack includes:
a second counter; and
a second control circuit configured to:
increase or decrease the second counter based on a charge/discharge current from the first battery or the second battery;
stop discharge from the first battery or the second battery based on the second counter exceeding a second threshold;
set the second threshold to a first battery threshold based on the battery pack including the first battery; and
set the second threshold to a second battery threshold different from the first battery threshold based on the battery pack including the second battery.

8. The electric work machine according to claim 2, wherein
the first control circuit is configured to decrease a decrease rate of the first counter according to an increase in count of stopping the motor based on the first counter exceeding the first threshold.

9. The electric work machine according to claim 2, wherein
the first control circuit is configured to:
stop decreasing the first counter based on a first time having reached a first time threshold during rotation of the motor, the first time corresponding to a time elapsed from starting to decrease the first counter during rotation of the motor.

10. The electric work machine according to claim 2, wherein
the first control circuit is configured (i) to decrease the first counter, and (ii) to stop decreasing the first counter based on a second time having reached a second time threshold during stop of the motor, the second time corresponding to a time elapsed from starting to decrease the first counter during stop of the motor.

11. The electric work machine according to claim 2, further comprising
a drive circuit configured to input an output of the power supply to the motor based on a voltage command value output from the first control circuit, the voltage command value being directed by the first control circuit and corresponding to a magnitude of a voltage input to the motor, wherein
the first control circuit is configured to calculate the speed threshold based on a power supply voltage value and/or the voltage command value, the power supply voltage value corresponding to a magnitude of a power supply voltage output from the power supply.

12. The electric work machine according to claim 11, wherein
the first control circuit is configured to calculate the speed threshold to be greater according to an increase in the power supply voltage value or the voltage command value.

13. The electric work machine according to claim 11, wherein
the voltage command value includes a duty ratio, and
the first control circuit is configured to calculate the speed threshold to be greater according to an increase in a product of the power supply voltage value and the duty ratio.

14. The electric work machine according to claim 2, further comprising
a voltage detection circuit configured to detect a motor voltage value, the motor voltage value corresponding to a magnitude of a voltage input to the motor, wherein
the first control circuit is configured to calculate the speed threshold based on the motor voltage value detected by the voltage detection circuit.

15. The electric work machine according to claim 14, wherein
the first control circuit is configured to calculate the speed threshold to be greater according to an increase in the motor voltage value detected by the voltage detection circuit.

16. The electric work machine according to claim 2, wherein
the first control circuit is configured to calculate a decrease rate of the first counter based on the first counter.

17. The electric work machine according to claim 16, wherein
the first control circuit is configured to calculate the decrease rate to be greater according to an increase in the first counter.

18. A method for controlling a motor, the method comprising:
increasing a counter based on a line current value being greater than a current threshold, the line current value corresponding to a magnitude of a current flowing through the motor;
decreasing the counter based on a rotational speed of the motor being greater than a speed threshold; and
stopping the motor based on the counter exceeding a counter threshold.
